(19) United States
(12) Patent Application Publication
(10) Pub. No.: US 2026/0203992 A1
(43) Pub. Date: Jul. 16, 2026

(54) THREE-DIMENSIONAL NAVIGATION VEHICLE ICON CREATION METHOD AND APPARATUS, DEVICE, MEDIUM, AND PROGRAM PRODUCT

(71) Applicant: TENCENT TECHNOLOGY (SHENZHEN) COMPANY LIMITED, Shenzhen (CN)

(72) Inventors: Peishi ZHANG, Shenzhen (CN); Ziji Wang, Shenzhen (CN); Yuxian Chen, Shenzhen (CN); Hang Jiang, Shenzhen (CN); Shuang Wang, Shenzhen (CN); Chao Dong, Shenzhen (CN); Yuntong Zhu, Shenzhen (CN); Jiayin Zhang, Shenzhen (CN)

(73) Assignee: TENCENT TECHNOLOGY (SHENZHEN) COMPANY LIMITED, Shenzhen (CN)

(21) Appl. No.: 19/563,447

(22) Filed: Mar. 11, 2026

Related U.S. Application Data
(63) Continuation of application No. PCT/CN2024/112714, filed on Aug. 16, 2024.

(30) Foreign Application Priority Data
Nov. 10, 2023 (CN) 202311502775.4

(51) Int. Cl. G06T 15/04; G06T 7/80; G06V 10/46

(52) U.S. Cl. CPC G06T 15/04; G06T 7/80; G06V 10/469

(57) ABSTRACT

Three-dimensional navigation vehicle icon creation methods and apparatus, devices, and storage medium are described. The method includes: displaying material images of a first object on an image capture interface in response to an operation of capturing images, the material images including images obtained by shooting the first object from different shooting angles, and the first object being a three-dimensional physical object in a real-world environment; displaying a three-dimensional navigation vehicle icon of the first object, the three-dimensional navigation vehicle icon being obtained by performing three-dimensional reconstruction on the first object based on the material images; and displaying an adjusted three-dimensional navigation vehicle icon in response to an operation of adjusting a display style of the three-dimensional navigation vehicle icon, the adjusted three-dimensional navigation vehicle icon being displayed on a navigation interface.

### RELATED APPLICATION

This application is a continuation application of PCT Patent Application No. PCT/CN2024/112714, filed on August 16, 2024, which claims priority to Chinese Patent Application No. 202311502775.4, filed with the China National Intellectual Property Administration on November 10, 2023, both of which are incorporated herein by reference in their entireties.

### FIELD OF THE TECHNOLOGY

The present disclosure relates to the technical field of map navigation, and in particular, to creation of a three-dimensional navigation vehicle icon.

### BACKGROUND OF THE DISCLOSURE

The rise and development of navigation application programs make people's travel activities more convenient. When a navigation application program is used to help a user determine a position of the user on a navigation interface, a positioning point needs to be displayed on the navigation interface.

In the related technology, to improve the identification capability of the positioning point, a navigation application program provides a three-dimensional (3D) skeletal vehicle icon for the user, and displays the 3D skeletal vehicle icon as the positioning point on the navigation interface. In a process of producing the 3D skeletal vehicle icon, a staff member produces a dynamic 3D skeletal vehicle icon by using 3D modeling software. After the 3D skeletal vehicle icon is created, the 3D skeletal vehicle icon is added to the navigation application program for the user.

However, in the related technology, a 3D skeletal vehicle icon creation period is long, the process of producing the 3D skeletal vehicle icon needs to be engaged by a plurality of parties, and development costs of the 3D skeletal vehicle icon are high.

The present disclosure describes embodiments for creating a three-dimensional navigation vehicle icon, addressing at least one of the problems/issues discussed above. Compared with the generation of a 3D skeletal vehicle icon in the related technology, various embodiments in the present disclosure include performing three-dimensional reconstruction on material images of an object, to generate and display a three-dimensional navigation vehicle icon of the object. Various embodiments in the present disclosure may satisfy a user’s demand for customizing three-dimensional navigation vehicle icons, enriching types of the three-dimensional navigation vehicle icons, reducing production costs of the three-dimensional navigation vehicle icon, and/or shortening a generation period of the three-dimensional navigation vehicle icon.

### SUMMARY

The present disclosure provides a three-dimensional navigation vehicle icon creation method and apparatus, a device, a storage medium, and a program product. The technical solutions are as follows:

The present disclosure describes a method for creating a three-dimensional navigation vehicle icon. The method is executed by a device including a memory storing instructions and a processor in communication with the memory. The method includes: obtaining material images of a first object, the material images comprising images obtained by shooting the first object from different angles, and the first object being a three-dimensional physical object in a real-world environment; performing key point identification on the material images, to generate point cloud data of the first object, the point cloud data being configured for describing a position and a display style of a key point of the first object in the real-world environment; performing three-dimensional reconstruction based on the point cloud data, to determine an original surface texture of the first object, the original surface texture being configured for reflecting a surface material of the first object; and performing texture mapping on the point cloud data according to the surface texture of the first object, and creating a three-dimensional navigation vehicle icon of the first object for being displayed on a navigation interface.

The present disclosure describes an apparatus for creating a three-dimensional navigation vehicle icon. The apparatus includes a memory storing instructions; and a processor in communication with the memory. When the processor executes the instructions, the processor is configured to cause the apparatus to perform: obtaining material images of a first object, the material images comprising images obtained by shooting the first object from different angles, and the first object being a three-dimensional physical object in a real-world environment; performing key point identification on the material images, to generate point cloud data of the first object, the point cloud data being configured for describing a position and a display style of a key point of the first object in the real-world environment; performing three-dimensional reconstruction based on the point cloud data, to determine an original surface texture of the first object, the original surface texture being configured for reflecting a surface material of the first object; and performing texture mapping on the point cloud data according to the surface texture of the first object, and creating a three-dimensional navigation vehicle icon of the first object for being displayed on a navigation interface.

The present disclosure describes a non-transitory computer-readable storage medium, storing computer-readable instructions. The computer-readable instructions, when executed by a processor, are configured to cause the processor to perform: obtaining material images of a first object, the material images comprising images obtained by shooting the first object from different angles, and the first object being a three-dimensional physical object in a real-world environment; performing key point identification on the material images, to generate point cloud data of the first object, the point cloud data being configured for describing a position and a display style of a key point of the first object in the real-world environment; performing three-dimensional reconstruction based on the point cloud data, to determine an original surface texture of the first object, the original surface texture being configured for reflecting a surface material of the first object; and performing texture mapping on the point cloud data according to the surface texture of the first object, and creating a three-dimensional navigation vehicle icon of the first object for being displayed on a navigation interface.

According to an aspect of embodiments of the present disclosure, a three-dimensional navigation vehicle icon creation method is provided. The method includes:

displaying material images of a first object on an image capture interface in response to an operation of capturing images, the material images including images obtained by shooting the first object from different shooting angles, and the first object being a three-dimensional physical object in a real-world environment;

displaying a three-dimensional navigation vehicle icon of the first object, the three-dimensional navigation vehicle icon being obtained by performing three-dimensional reconstruction on the first object based on the material images; and

displaying an adjusted three-dimensional navigation vehicle icon in response to an operation of adjusting a display style of the three-dimensional navigation vehicle icon, the adjusted three-dimensional navigation vehicle icon being displayed on a navigation interface.

According to an aspect of the embodiments of the present disclosure, a three-dimensional navigation vehicle icon creation method is provided. The method includes:

obtaining material images of a first object, the material images including images obtained by shooting the first object from different angles, and the first object being a three-dimensional physical object in a real-world environment;

performing key point identification on the material images, to determine point cloud data of the first object, the point cloud data being configured for describing a position and a display style of a key point of the first object in the real-world environment;

performing three-dimensional reconstruction based on the point cloud data, to determine an original surface texture of the first object, the original surface texture being configured for reflecting a surface material of the first object; and

performing texture mapping on the point cloud data according to the surface texture of the first object, and creating a three-dimensional navigation vehicle icon of the first object, the three-dimensional navigation vehicle icon being displayed on a navigation interface.

According to an aspect of the embodiments of the present disclosure, a three-dimensional navigation vehicle icon creation apparatus is provided. The apparatus includes:

a material capture module, configured to display material images of a first object on an image capture interface in response to an operation of capturing images, the material images including images obtained by shooting the first object from different shooting angles, and the first object being a three-dimensional physical object in a real-world environment;

a vehicle icon display module, configured to display a three-dimensional navigation vehicle icon of the first object, the three-dimensional navigation vehicle icon being obtained by performing three-dimensional reconstruction on the first object based on the material images; and

a vehicle icon adjustment module, configured to display an adjusted three-dimensional navigation vehicle icon in response to an operation of adjusting a display style of the three-dimensional navigation vehicle icon, the adjusted three-dimensional navigation vehicle icon being displayed on a navigation interface.

According to an aspect of the embodiments of the present disclosure, a three-dimensional navigation vehicle icon creation apparatus is provided. The apparatus includes:

a material obtaining module, configured to obtain material images of a first object, the material images including images obtained by shooting the first object from different angles, and the first object being a three-dimensional physical object in a real-world environment;

a data determination module, configured to perform key point identification on the material images, to determine point cloud data of the first object, the point cloud data being configured for describing a position and a display style of a key point of the first object in the real-world environment;

a three-dimensional reconstruction module, configured to perform three-dimensional reconstruction based on the point cloud data, to determine an original surface texture of the first object, the original surface texture being configured for reflecting a surface material of the first object; and

a vehicle icon creation module, configured to perform texture mapping on the point cloud data according to the surface texture of the first object, and create a three-dimensional navigation vehicle icon of the first object, the three-dimensional navigation vehicle icon being displayed on a navigation interface.

According to an aspect of the embodiments of the present disclosure, a computer device is provided. The computer device includes a processor and a memory. The memory has a computer program stored therein, and the computer program is loaded and executed by the processor to implement the foregoing three-dimensional navigation vehicle icon creation method.

According to an aspect of the embodiments of the present disclosure, a computer-readable storage medium is provided. The storage medium has a computer program stored therein, and the computer program is loaded and executed by a processor to implement the foregoing three-dimensional navigation vehicle icon creation method.

According to an aspect of the embodiments of the present disclosure, a computer program product is provided. The computer program product includes a computer program, the computer program is stored in a computer-readable storage medium, and a processor reads the computer program from the computer-readable storage medium and executes the computer program to implement the foregoing three-dimensional navigation vehicle icon creation method.

The technical solutions provided in the embodiments of the present disclosure achieve at least the following beneficial effects:

Compared with a 3D skeletal vehicle icon generated in the related technology, three-dimensional reconstruction is performed on material images of a shot object that are uploaded by a user, to generate and display a three-dimensional navigation vehicle icon of the shot object. The three-dimensional navigation vehicle icon displayed on a navigation interface can be customized by the user, which satisfies a demand of the user for customizing three-dimensional navigation vehicle icons and enriches types of the three-dimensional navigation vehicle icons.

Moreover, a static three-dimensional navigation vehicle icon is generated automatically, which helps to reduce production costs of the three-dimensional navigation vehicle icon, and helps to shorten a generation period of the three-dimensional navigation vehicle icon. In this way, the three-dimensional navigation vehicle icon is obtained more conveniently and quickly, which helps to meet requirements for updating and iterating three-dimensional navigation vehicle icons.

### BRIEF DESCRIPTION OF THE DRAWINGS

FIG. 1 is a schematic diagram of an implementation environment according to an exemplary embodiment of the present disclosure.

FIG. 2 is a schematic diagram of an inventive concept according to an embodiment of the present disclosure.

FIG. 3 is a flowchart of a three-dimensional navigation vehicle icon creation method according to an exemplary embodiment of the present disclosure.

FIG. 4 is a schematic diagram of first prompt information according to an exemplary embodiment of the present disclosure.

FIG. 5 is a schematic diagram of uploading a material image according to an exemplary embodiment of the present disclosure.

FIG. 6 is a schematic diagram of second prompt information according to an exemplary embodiment of the present disclosure.

FIG. 7 is a schematic diagram of obtaining identifier information according to an exemplary embodiment of the present disclosure.

FIG. 8 is a schematic diagram of an orientation adjustment process according to an exemplary embodiment of the present disclosure.

FIG. 9 is a schematic diagram of an interface before entering an image capture interface according to an exemplary embodiment of the present disclosure.

FIG. 10 is a schematic diagram of a navigation interface according to an exemplary embodiment of the present disclosure.

FIG. 11 is a schematic diagram of a display effect of a three-dimensional navigation vehicle icon according to an exemplary embodiment of the present disclosure.

FIG. 12 is an interaction diagram of a vehicle icon application process according to an exemplary embodiment of the present disclosure.

FIG. 13 is a flowchart of a three-dimensional navigation vehicle icon creation method according to an exemplary embodiment of the present disclosure.

FIG. 14 is a block diagram of a three-dimensional navigation vehicle icon creation apparatus according to an exemplary embodiment of the present disclosure.

FIG. 15 is a block diagram of a three-dimensional navigation vehicle icon apparatus according to another exemplary embodiment of the present disclosure.

FIG. 16 is a structural block diagram of a computer device according to an exemplary embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

Driving scenario: it refers to a scenario that a user enters after starting a navigation process using a navigation application program. In other words, the driving scenario refers to an application scenario that begins when the navigation application program starts navigation for the user and ends when the navigation is completed.

Three-dimensional (3D) model: it refers to a 3D polygonal representation corresponding to an object. The 3D model of the object is configured to restore a form of the object in a real-world environment to some extent. The "object" mentioned herein may correspond to an object in the claims. The object may be an object in the real world, or may be a virtual object. The 3D model is typically generated using a 3D modeling tool.

3D navigation vehicle icon: it is configured to display a position of a user on a navigation interface. After the user sets a starting point and an end point in a navigation application program, and initiates navigation, a positioning point is displayed on the navigation interface, and a position of the user in a map is indicated by the positioning point. To make the positioning point more vivid and improve the interesting degree of the navigation interface, the 3D navigation vehicle icon may be displayed on the navigation interface instead of the positioning point. The 3D navigation vehicle icon belongs to a 3D model.

Object (OBJ) file: it is a standard 3D model file format, and is configured for performing model interaction between 3D software models. For example, after a 3D model is created in a 3D modeling tool such as 3dsMax or LightWave, an OBJ file of the 3D model is exported, and the 3D model is imported into Maya by using the OBJ file to render or generate a model animation.

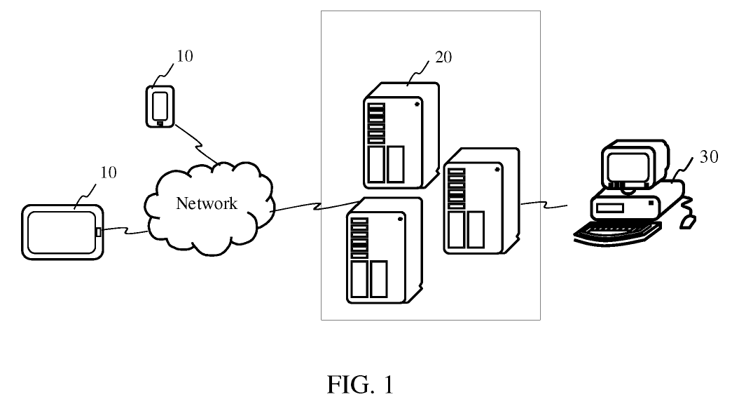

FIG. 1 is a schematic diagram of an implementation environment according to an exemplary embodiment of the present disclosure. The solution implementation environment may include: a terminal device 10, a server 20, and a computer device 30.

The terminal device 10 may be an electronic device such as a computer, a tablet computer, a mobile phone, a wearable device, a smart home appliance, an in-vehicle terminal, or an aircraft. A client of a target application program runs on the terminal device 10. The target application program may be an independent application program, or may be a child application program in a parent application program. The target application program is configured for providing a function of creating a three-dimensional vehicle icon.

Exemplarily, the target application program belongs to a three-dimensional model production application program. After creating a three-dimensional navigation vehicle icon in the target application program, a user imports the three-dimensional navigation vehicle icon into a navigation application program. When the navigation application program provides navigation for the user, the three-dimensional navigation vehicle icon is displayed. Exemplarily, the target application program belongs to a navigation application program, and the target application program provides a function of creating a three-dimensional navigation vehicle icon.

In an embodiment, the terminal device 10 is provided with a camera, or an image transmission path exists between the terminal device 10 and a camera. The terminal device 10 obtains material images of a shot object through the camera, and transmits the material images to the server to initiate a process of creating a three-dimensional navigation vehicle icon, to obtain the three-dimensional navigation vehicle icon.

The server 20 is configured to provide a backend service for the client of the target application program in the terminal device 10. For example, the server 20 may be, but is not limited to, an independent physical server, a server cluster or a distributed system formed by a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and an artificial intelligent platform. The server 20 has at least a data receiving function.

The computer device 30 includes, but is not limited to, an electronic device such as a mobile phone, a desktop computer, a tablet computer, a notebook computer, an in-vehicle terminal, a server, an intelligent robot, a smart television, or a multimedia playback device, or some other electronic devices having a relatively strong computing capability. This is not limited in the present disclosure.

In a solution of creating a three-dimensional navigation vehicle icon provided in the present disclosure, the computer device 30 is responsible for calculation on an algorithm side. To be specific, the computer device 30 performs three-dimensional reconstruction according to the material images, to create a three-dimensional navigation vehicle icon.

A function of creating a three-dimensional navigation vehicle icon of the computer device 30 may be implemented by the server 20 (that is, the computer device 30 and the server 20 are a same device). Alternatively, the computer device 30 and the server 20 are two devices independent of each other. After completing the creation of the three-dimensional navigation vehicle icon, the computer device 30 transmits the three-dimensional navigation vehicle icon to the server 20, and the server 20 feeds back the three-dimensional navigation vehicle icon to the terminal device 10.

In an example, after receiving the material images uploaded by the terminal device 10 through the target application program, the server 20 transmits the material images to the computer device 30. The computer device 30 performs three-dimensional reconstruction based on the material images, to determine the three-dimensional navigation vehicle icon. The computer device 30 transmits the three-dimensional navigation vehicle icon to the server 20, and the server 20 provides the three-dimensional navigation vehicle icon for the terminal device 10.

In another example, the computer device 30 obtains material images over a network, and creates a three-dimensional navigation vehicle icon based on the material images. Subsequently, the computer device 30 stores the three-dimensional navigation vehicle icon, or transmits the three-dimensional navigation vehicle icon to the server 20.

In another example, the terminal device 10 directly transmits the material images to the computer device 30 through the target application program. After generating the three-dimensional navigation vehicle icon based on the material images, the computer device 30 feeds back the three-dimensional navigation vehicle icon to the terminal device 10.

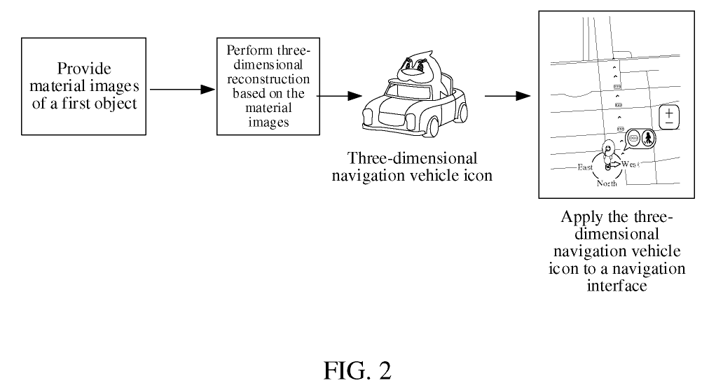

FIG. 2 is a schematic diagram of an inventive concept according to an embodiment of the present disclosure.

In an embodiment provided in the present disclosure, a terminal device captures material images. In this way, a user can capture material images of a shot object according to an actual requirement. Subsequently, the terminal device transmits the material images to a computer device for three-dimensional reconstruction, to obtain a three-dimensional navigation vehicle icon. In a process in which the terminal device performs navigation through a navigation application program, the three-dimensional navigation vehicle icon may be displayed on a navigation interface. In this manner, generation costs of the three-dimensional navigation vehicle icon are reduced, and the three-dimensional navigation vehicle icon can be conveniently created on a mobile terminal.

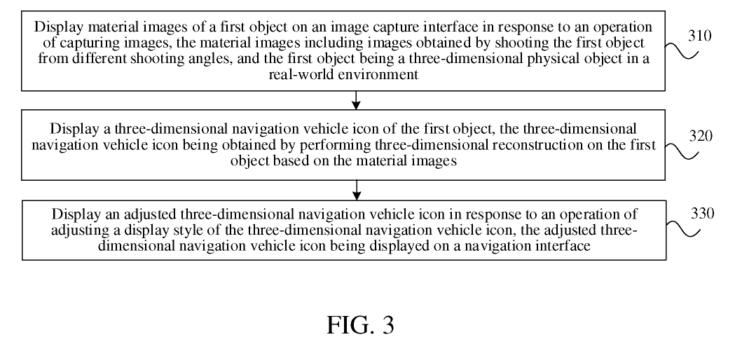

FIG. 3 is a flowchart of a three-dimensional navigation vehicle icon creation method according to an exemplary embodiment of the present disclosure. Exemplarily, an execution body of the method may be the terminal device 10 in FIG. 1. The following describes the three-dimensional navigation vehicle icon creation method by using a terminal device as the execution body. As shown in FIG. 3, the method may include the following operations (310 to 330).

Operation 310: Display material images of a first object on an image capture interface in response to an operation of capturing images, the material images including images obtained by shooting a first object from different shooting angles, and the first object being a three-dimensional physical object in a real-world environment. In some implementations, Operation 310 may include displaying material images of a first object on an image obtaining interface in response to an operation of obtaining images, the material images including images obtained by shooting a first object from different shooting angles, and the first object being a three-dimensional physical object in a real-world environment. In some implementations, Operation 310 may include a portion or all of the following: obtaining images of a first object from different shooting angles; and/or displaying material images of the first object on an image obtaining interface, the material images including the images, and the first object being a three-dimensional physical object in a real-world environment.

In some implementations, “shooting” an object may include “taking photo(s)” of an object, or “taking video(s)” of an object, or “taking both photo(s) and video(s)” of an object.

In some embodiments, the first object is any three-dimensional physical object in the real-world environment. For example, the first object is an object, a person, a building, or the like in the real-world environment. The first object may be customized and selected by a user. If the user needs to create a three-dimensional navigation vehicle icon corresponding to an object, the object is used as the first object, and material images of the first object are captured by the terminal device. The first object may alternatively be referred to as a shot object.

In some embodiments, the material images are configured for representing a form of the first object in the real-world environment. A type of material image includes, but is not limited to, at least one of the following: a video and an image group. For example, when the material images are a video, an image included in the material images is a video frame in the video. For another example, when the material images are an image group, an image included in the material images refers to any image in the image group.

In an embodiment, the material images include a plurality of images, and the plurality of images are all obtained by shooting the first object. Exemplarily, at least one of the following is recorded in the plurality of images: a front surface, a side surface, a back surface, a top surface, and the like of the first object. The plurality of images are obtained by shooting the first object from different shooting angles. The shooting angle includes at least one of the following: a shooting height, a shooting direction, and a shooting distance.

The image capture interface (or referred as image obtaining interface) is configured to display the material images of the first object. In some embodiments, the operation of capturing the images is configured for obtaining the material images. The operation of capturing the images includes, but is not limited to, at least one of the following: a click/tap operation, a key operation, a slide operation, a touch and hold operation, and the like. Exemplarily, an image capture control is displayed on the image capture interface, and the terminal device displays the material images on the image capture interface in response to an operation of triggering the image capture control.

Exemplarily, a source of the material images of the first object includes, but is not limited to, at least one of the following: Internet downloading, storage in a local database of the terminal device, and real-time capture using the terminal device. For example, the terminal device shoots and records the first object in real time through a camera on the image capture interface, to obtain the material images of the first object. For example, the terminal device stores a material image of the first object in a multimedia database, and when a three-dimensional navigation vehicle icon needs to be generated, the terminal device uploads the material images of the first object to the image capture interface.

Operation 320: Display a three-dimensional navigation vehicle icon of the first object, the three-dimensional navigation vehicle icon being obtained by performing three-dimensional reconstruction on the first object based on the material images. In some implementations, Operation 320 may include a portion or all of the following steps: performing three-dimensional reconstruction on the first object based on the material images to obtain a three-dimensional navigation vehicle icon of the first object; and/or displaying the three-dimensional navigation vehicle icon of the first object.

In some embodiments, the three-dimensional navigation vehicle icon of the first object refers to a 3D model that has a space structure similar to that of the first object. The three-dimensional navigation vehicle icon of the first object is displayed on a navigation interface as a positioning point in a navigation process. In an embodiment, in the navigation process, a display location and a posture of the three-dimensional navigation vehicle icon on the navigation interface are related to a position and a posture of the terminal device in the real-world environment. The three-dimensional navigation vehicle icon is displayed on the navigation interface, to help the user determine a current position of the user on the navigation interface. By defining and uploading the material images by the user, it is ensured that the user obtains a personalized three-dimensional navigation vehicle icon.

In an embodiment, the three-dimensional navigation vehicle icon is a static 3D model, that is, a shape and a structure of the three-dimensional navigation vehicle icon do not change during use. The three-dimensional navigation vehicle icon belonging to a static 3D model is generated, which not only helps to improve efficiency of the three-dimensional navigation vehicle icon, but also helps to reduce display overheads of displaying the three-dimensional navigation vehicle icon on the navigation interface, and helps to reduce power consumption of the terminal device.

In some embodiments, after the material images of the first object are displayed on the image capture interface, a process of creating a three-dimensional navigation vehicle icon is started. Exemplarily, the terminal device starts to create the three-dimensional navigation vehicle icon of the first object in response to an operation of performing three-dimensional reconstruction on the first object. Exemplarily, in response to that/when the material images satisfy a creation condition, the terminal device starts to create the three-dimensional navigation vehicle icon of the first object.

In an embodiment, the process of creating the three-dimensional navigation vehicle icon is completed by the terminal device, or may be completed by a backend device of a target application program. The backend device includes the computer device in the foregoing implementation environment. Exemplarily, after obtaining the material images of the first object, the terminal device transmits the material images of the first object to the computer device, and the computer device creates the three-dimensional navigation vehicle icon of the first object based on the material images of the first object, and feeds back the three-dimensional navigation vehicle icon of the first object to the terminal device. Subsequently, the terminal device displays the three-dimensional navigation vehicle icon of the first object. Because the process of creating the three-dimensional navigation vehicle icon of the first object has a high requirement for computation performance, creation of the three-dimensional navigation vehicle icon of the first object by the backend device of the target application program helps to shorten time consumed in the creation process.

Operation 330: Display an adjusted three-dimensional navigation vehicle icon in response to an operation of adjusting a display style of the three-dimensional navigation vehicle icon, the adjusted three-dimensional navigation vehicle icon being displayed on a navigation interface. In some implementations, Operation 330 may include a portion or all of the following: adjusting a display style of the three-dimensional navigation vehicle icon; and/or displaying the adjusted three-dimensional navigation vehicle icon on a navigation interface.

In some embodiments, the display style of the three-dimensional navigation vehicle icon is configured for controlling a display effect of the three-dimensional navigation vehicle icon. In an embodiment, the display style of the three-dimensional navigation vehicle icon includes at least one of the following: a surface texture of the three-dimensional navigation vehicle icon, a display size of the three-dimensional navigation vehicle icon, and a display orientation of the three-dimensional navigation vehicle icon. The surface texture of the three-dimensional navigation vehicle icon includes, but is not limited to, a display color, a surface material, a pattern, and the like of the three-dimensional navigation vehicle icon. The display size of the three-dimensional navigation vehicle icon refers to a size occupied by displaying the three-dimensional navigation vehicle icon. The display orientation of the three-dimensional navigation vehicle icon is alternatively referred to as an orientation of the three-dimensional navigation vehicle icon, and is configured for representing a bearing of the three-dimensional navigation vehicle icon.

The display style of the first object in the real-world environment may not completely conform to the preference of the user. By adjusting the display style of the three-dimensional navigation vehicle icon, the adjusted three-dimensional navigation vehicle icon better meets a requirement of the user, which helps to implement customization of the three-dimensional navigation vehicle icon. In addition, by this method, the display style of the three-dimensional navigation vehicle icon is adjusted in a later period, which reduces a requirement for the material images, and helps to reduce difficulty in capturing the material images.

In an embodiment, the operation of adjusting the display style of the three-dimensional navigation vehicle icon includes, but is not limited to, at least one of the following: a click/tap operation, a key operation, a slide operation, a touch and hold operation, and the like. For specific content about adjusting the display style of the three-dimensional navigation vehicle icon, refer to the following embodiments.

In some embodiments, after the display style of the three-dimensional navigation vehicle icon is adjusted, the terminal device stores the adjusted three-dimensional navigation vehicle icon. When the navigation application program is run for navigation on the terminal device, the terminal device displays the adjusted three-dimensional navigation vehicle icon on the navigation interface.

In an example, a first user account is logged in to the target application program on the terminal device. The first user account possesses a plurality of three-dimensional navigation vehicle icons, and an ownership relationship between the first user account and the plurality of navigation vehicle icons is stored in a server. In response to an operation of adjusting a display style of a first navigation vehicle icon in the plurality of three-dimensional navigation vehicle icons, the terminal device displays an adjusted first navigation vehicle icon, and transmits vehicle icon update information to the server. The server generates the adjusted first navigation vehicle icon according to the vehicle icon update information, and establishes an ownership relationship between the first user account and the adjusted first navigation vehicle icon.

In conclusion, compared with the generation of a 3D skeletal vehicle icon in the related technology, three-dimensional reconstruction is performed on material images of a shot object that are uploaded by a user, to generate and display a three-dimensional navigation vehicle icon of the shot object. The three-dimensional navigation vehicle icon displayed on a navigation interface can be customized by the user, which satisfies a demand of the user for customizing three-dimensional navigation vehicle icons and enriches types of the three-dimensional navigation vehicle icons.

Moreover, a static three-dimensional navigation vehicle icon is generated automatically, which helps to reduce production costs of the three-dimensional navigation vehicle icon, and helps to shorten a generation period of the three-dimensional navigation vehicle icon. In this way, the three-dimensional navigation vehicle icon is obtained more conveniently and quickly, which helps to meet requirements for updating and iterating three-dimensional navigation vehicle icons.

In some embodiments, an image capture control is displayed on the image capture interface. Before the terminal device displays the material images of the first object on the image capture interface, the method further includes: operation 305 (not shown in the figure): The terminal device displays, on the image capture interface in response to an operation of triggering the image capture control, a field-of-view image of a process in which a camera captures the first object, the field-of-view image corresponding to the image; the terminal device displays first prompt information on a top layer of the field-of-view image, the first prompt information prompting a recommended movement trajectory for the camera to capture the first object; and the terminal device starts, in response to an operation of completing the capture of the images, to perform the operation of displaying the material images of the first object on the image capture interface.

In an embodiment, the material images are a video about the first object. In a process of recording the video about the first object, the camera moves around the first object, and continuously captures the form of the first object at different shooting angles. Exemplarily, the video about the first object is recorded in real time on the image capture interface.

In an embodiment, the field-of-view image is a field-of-view image of the camera displayed on the terminal device in the process of shooting the first object. After it is determined that the shooting is completed, the field-of-view images are images included in the material images.

The image capture control is configured to obtain a material image of the first object in real time. In an embodiment, the operation of triggering the image capture control includes, but is not limited to, a click/tap operation, a slide operation, a gesture operation, a key operation, and the like.

In some embodiments, the terminal device invokes a camera component in response to the operation of triggering the image capture control. The camera component is configured to control the camera to capture a material image of the first object. The image capture control displays a field-of-view image of the process in which the camera captures the first object.

To ensure that the material image collected by the user can be loaded with details related to the form of the first object, the plurality of images included in the material images are collected from continuously changing shooting angles. In the process in which the camera collects the material images of the first object, the terminal device displays the first prompt information on the top layer of the field-of-view image. In an embodiment, the first prompt information includes at least one of the following: the recommended movement trajectory for the camera to capture the first object, and a recommended position of the first object in the field-of-view image.

Exemplarily, the recommended movement trajectory includes at least one of the following: shooting the first object during a 360-degree clockwise rotation, or shooting the first object during a 360-degree anticlockwise rotation. Exemplarily, the recommended position in the field-of-view image belongs to a central area of the field-of-view image.

The first prompt information is displayed, to instruct the user to shoot the first object along the recommended movement trajectory, and to enable the first object to be located at the recommended position in the field-of-view image.

Exemplarily, a type of the first prompt information includes, but is not limited to, at least one of the following: text information, icon information, and animation information. For example, the first prompt information includes text information: "Please take a 360° shot around the first object". In an example, the first prompt information is looped through a page animation, prompting the user that shooting needs to be performed by rotating 360° around an object, to ensure content integrity of material images.

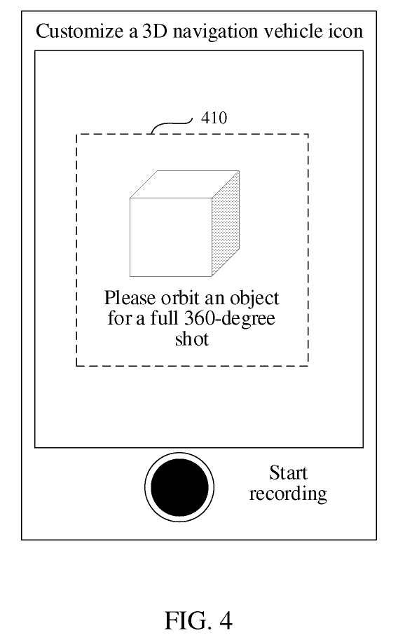

FIG. 4 is a schematic diagram of first prompt information according to an exemplary embodiment of the present disclosure.

As shown in FIG. 4, first prompt information 410 includes a piece of cube animation information that continuously rotates horizontally, and prompts to perform a 360° shot of the first object.

After completing the capture of the material images, the terminal device displays the material images on the image acquisition interface, and uploads the material images, to obtain the three-dimensional navigation vehicle icon of the first object created by the computer device.

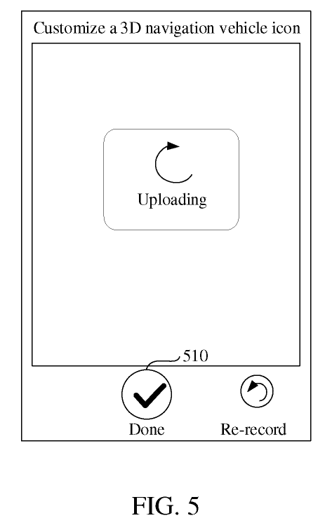

FIG. 5 is a schematic diagram of uploading a material image according to an exemplary embodiment of the present disclosure.

As shown in FIG. 5, after completing the capture of the material images, the terminal device uploads the material images.

In some embodiments, a capture completion control 510 is displayed on the image capture interface, and the operation of completing the capture of the material images refers to an operation of triggering the capture completion control 510. For example, the capture completion control is clicked/tapped.

In an embodiment, a display position of the capture completion control and a display position of the image capture control on the image collection interface are the same. After displaying, on the image capture interface in response to the operation of triggering the image capture control, the field-of-view image of the process in which the camera captures the first object, the terminal device displays the capture completion control at the display position of the image capture control, and cancels displaying the image capture control.

The material images of the first object are obtained through real-time shooting, and the prompt information is displayed in the field-of-view image. This helps ensure that the material images record the shot object in the shooting direction, and helps improve the fineness of the three-dimensional navigation vehicle icon generated based on the material images. In this way, the three-dimensional navigation vehicle icon more closely resembles the shot object.

The process in which the terminal device uploads the material images is introduced and described below by using several embodiments.

In some embodiments, before the terminal device displays the three-dimensional navigation vehicle icon of the first object, the method further includes operation 313 (not shown in the figure): The terminal device displays second prompt information in response to an operation of performing three-dimensional reconstruction on the first object, the second prompt information prompting remaining creation duration of the three-dimensional navigation vehicle icon; and the terminal device updates the second prompt information at a first time interval if the remaining creation duration is greater than the first time interval, and displays updated second prompt information until the creation of the three-dimensional navigation vehicle icon is completed.

In some embodiments, the operation of performing three-dimensional reconstruction on the first object is configured for controlling the terminal device to upload the material images of the first object. To be specific, the terminal device initiates, through the operation of performing three-dimensional reconstruction on the first object, the process of creating the three-dimensional navigation vehicle icon.

In an embodiment, the remaining creation duration is configured for representing required waiting duration before the three-dimensional navigation vehicle icon is obtained. The first time interval is preset. For example, the first time interval is equal to 30 seconds.

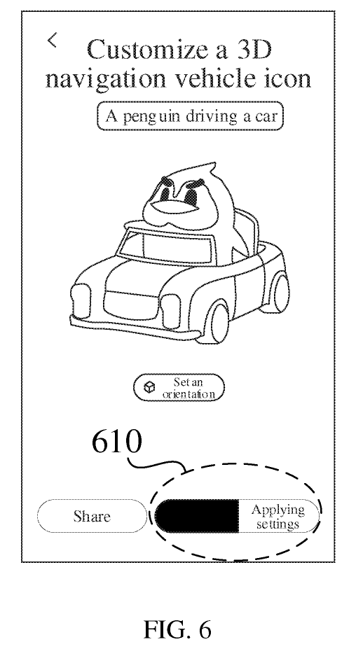

FIG. 6 is a schematic diagram of second prompt information according to an exemplary embodiment of the present disclosure. A display effect of the second prompt information is shown as 610.

In an embodiment, the terminal device transmits the material images to the computer device in response to the operation of performing three-dimensional reconstruction on the first object, and obtains the second prompt information from the computer device. The terminal device displays the second prompt information and records display duration of the second prompt information. The terminal device obtains the updated second prompt information from the computer device if the display duration of the second prompt information is equal to the first time interval. The terminal device displays the updated second prompt information, and starts to record display duration of the second prompt information again. The terminal device starts to perform the operation of "The terminal device obtains the updated second prompt information from the computer device if the display duration of the second prompt information is equal to the first time interval" until the computer device completes the creation of the three-dimensional navigation vehicle icon.

By a polling method, the remaining creation duration is updated at particular time intervals, which not only can provide relatively accurate remaining creation duration for the user, but also avoids communication overheads caused by frequently updating the remaining creation duration.

Because generation of a three-dimensional navigation model based on the material images needs a large amount of calculation, and calculation performance of a computer device is limited, to prevent excessively large data of the material images from affecting normal generation of the three-dimensional navigation vehicle icon, in addition to initiating, by the user through the operation of performing three-dimensional reconstruction on the first object, the operation of creating the three-dimensional navigation vehicle icon, the following further provides a method for automatically triggers a process of creating a three-dimensional navigation vehicle icon by a terminal device.

In some embodiments, the three-dimensional navigation vehicle icon creation method further includes operation 316 (not shown in the figure): The terminal device displays the second prompt information if a data volume of the material images reaches an upper limit value and the operation of performing three-dimensional reconstruction on the first object is not received.

In an embodiment, the data volume of the material images is configured for measuring a total quantity of images included in the material images. A larger total quantity of images included in the material images indicates a larger data volume of the material images. A smaller total quantity of images included in the material images indicates a smaller data volume of the material images. In an embodiment, the upper limit value of the data volume is a maximum data volume of the material images. The upper limit value of the data volume may be preset. For example, the upper limit value of the data volume is 600 images.

For material images belonging to an image group, the data volume of the material images is equal to a quantity of images included in the image group. For material images belonging to a video, a data volume of the material images may equal to duration of the video. In this case, the upper limit of the data volume refers to maximum recording duration of the video. For example, the upper limit value of the data volume is equal to 60 seconds.

Exemplarily, fourth prompt information is further displayed on the image capture interface. The fourth prompt information is configured for representing maximum remaining recording duration of the video. In response to that/when the maximum remaining recording duration of the video is 0, it indicates that the data volume of the material images reaches the upper limit value of the data volume, and the terminal device transmits the material images to the computer device and displays the second prompt information.

The quantity of images included in the material images is limited by the upper limit value of the data volume, which helps reduce calculation pressure in the process of generating the three-dimensional navigation vehicle icon, and helps shorten waiting duration for obtaining the three-dimensional navigation vehicle icon.

In some embodiments, after the terminal device displays the material images of the first object on the image capture interface in response to the operation of capturing the images, the method further includes: The terminal device displays identifier information of the three-dimensional navigation vehicle icon in response to an operation of setting the identifier information, the identifier information being configured for uniquely identifying the three-dimensional navigation vehicle icon; and the terminal device performs the operation of displaying the three-dimensional navigation vehicle icon of the first object in response to that/when the identifier information of the three-dimensional navigation vehicle icon conforms to a naming rule and the material images conform to a content rule.

In some embodiments, the identifier information of the three-dimensional navigation vehicle icon includes, but is not limited to, a name, a number, and the like of the three-dimensional navigation vehicle icon. In an embodiment, the identifier information of the three-dimensional navigation vehicle icon supports customization. Exemplarily, the terminal device transmits the material images to the computer device in response to the operation of performing three-dimensional reconstruction on the first object, and displays an identifier input interface. A name input control is displayed on the identifier input interface. The operation of setting the identifier information is an input operation for the name input control, and the terminal device obtains the identifier information of the three-dimensional navigation vehicle icon through the operation of setting the identifier information.

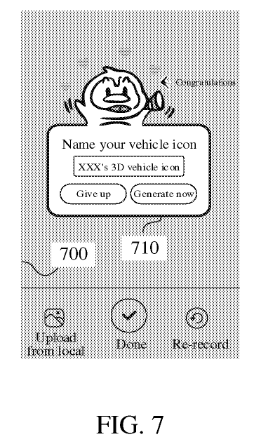

FIG. 7 is a schematic diagram of obtaining identifier information according to an exemplary embodiment of the present disclosure. As shown in FIG. 7, a name input control 710 is displayed on an identifier input interface 700.

In an embodiment, after obtaining the identifier information of the three-dimensional navigation vehicle icon, the terminal device transmits the identifier information of the three-dimensional navigation vehicle icon to the server. The server performs a compliance check on the identifier information of the three-dimensional navigation vehicle icon. The terminal device displays fifth prompt information in response to that/when the identifier information of the three-dimensional navigation vehicle icon fails to pass the compliance check. The fifth prompt information prompts identifier information of a re-inputted three-dimensional navigation vehicle icon. The terminal device displays the second prompt information in response to that/when the identifier information of the three-dimensional navigation vehicle icon passes the compliance check.

The compliance check is performed on the identifier information and the material images, which can avoid cases in which the generated three-dimensional navigation vehicle icon is abnormal and a name is displayed improperly, and improves the generation accuracy and efficiency of the three-dimensional navigation vehicle icon.

The process of adjusting the display style of the three-dimensional navigation vehicle icon is described below by using several embodiments. It can be known from the foregoing embodiments that the display style of the three-dimensional navigation vehicle icon includes at least one of the following: a surface texture of the three-dimensional navigation vehicle icon, a display size of the three-dimensional navigation vehicle icon, and a display orientation of the three-dimensional navigation vehicle icon. After the three-dimensional navigation vehicle icon is created, the user may select, according to an actual requirement, whether the display style of the three-dimensional navigation vehicle icon needs to be adjusted. The following several examples of adjusting the display style may be independently implemented or may be freely combined.

Example 1: Adjustment of an orientation of a three-dimensional navigation vehicle icon on a navigation interface.

In some embodiments, the display style includes: an orientation of the three-dimensional navigation vehicle icon on the navigation interface; and operation 330 may be implemented as the following several operations.

Sub-operation 331-a: The terminal device rotates the orientation of the three-dimensional navigation vehicle icon in response to an operation of adjusting a posture of the three-dimensional navigation vehicle icon.

In some embodiments, the orientation of the three-dimensional navigation vehicle icon on the navigation interface refers to a bearing of the three-dimensional navigation vehicle icon on the navigation interface. The orientation of the three-dimensional navigation vehicle icon on the navigation interface may be understood as a main view direction of the three-dimensional navigation vehicle icon.

In some embodiments, the operation of adjusting the posture of the three-dimensional navigation vehicle icon is configured for adjusting an orientation angle of the three-dimensional navigation vehicle icon, and the orientation of the three-dimensional navigation vehicle icon on the navigation interface is rotated by adjusting the orientation angle of the three-dimensional navigation vehicle icon. The operation of adjusting the posture of the three-dimensional navigation vehicle icon includes, but is not limited to, a slide operation, a key operation, a gesture operation, a voice operation, and the like.

In an embodiment, the operation of adjusting the posture of the three-dimensional navigation vehicle icon is a slide operation, and the terminal device controls, in response to the operation of adjusting the posture of the three-dimensional navigation vehicle icon, the three-dimensional navigation vehicle icon to rotate in a target rotation direction, to change the orientation of the three-dimensional navigation vehicle icon. The target rotation direction is rotation corresponding to the slide operation.

Exemplarily, the target rotation direction is related to a direction of the slide operation. For example, a target rotation direction corresponding to an up-down slide operation is configured for adjusting a pitch angle of the three-dimensional navigation vehicle icon. A target rotation direction corresponding to a left-right slide operation is configured for adjusting a yaw angle of the three-dimensional navigation vehicle icon.

Exemplarily, the target rotation direction is related to an occurrence area of the slide operation. For example, a target rotation direction corresponding to a slide operation in an area 1/3 of an upper part of the terminal device is configured for adjusting a pitch angle of the three-dimensional navigation vehicle icon. A target rotation direction corresponding to a slide operation in an area 1/3 of a middle part of the terminal device is configured for adjusting a yaw angle of the three-dimensional navigation vehicle icon.

A specific implementation of the operation of adjusting the three-dimensional navigation vehicle icon is set according to an actual requirement. This is not limited in the present disclosure.

In some embodiments, the terminal device determines the target rotation direction after receiving the operation of adjusting the posture of the three-dimensional navigation vehicle icon. The terminal device rotates the three-dimensional navigation vehicle icon in response to the operation of adjusting the posture of the three-dimensional navigation vehicle icon, to continuously change the orientation of the three-dimensional navigation vehicle icon.

Sub-operation 331-b: The terminal device displays an adjusted three-dimensional navigation vehicle icon in response to an operation of ending the adjustment of the posture of the three-dimensional navigation vehicle icon.

In an embodiment, the operation of ending the adjustment of the gesture of the three-dimensional navigation vehicle icon includes, but is not limited to, at least one of the following: a slide operation, a key operation, a gesture operation, a voice operation, and the like.

Exemplarily, in response to that/when the operation of adjusting the posture of the three-dimensional navigation vehicle icon is a slide operation, the operation of ending the adjustment of the posture of the three-dimensional navigation vehicle icon may be disappearance of a slide signal. That is, the terminal device rotates the three-dimensional navigation vehicle icon in response to the slide signal of the slide operation. The terminal device displays the adjusted three-dimensional navigation vehicle icon in response to that/when the slide operation disappears.

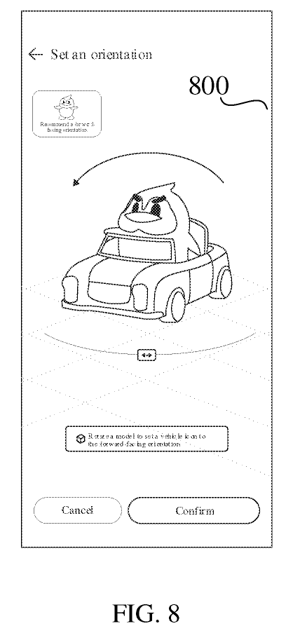

FIG. 8 is a schematic diagram of an orientation adjustment process according to an exemplary embodiment of the present disclosure. An orientation of a three-dimensional navigation vehicle icon can be adjusted on an orientation adjustment interface 800.

Because the three-dimensional navigation vehicle icon has a three-dimensional structure, display effects of the three-dimensional navigation vehicle icon in different orientations are different. The orientation of the three-dimensional navigation vehicle icon is adjusted, which enriches display effects of the three-dimensional navigation vehicle icon on the navigation interface, helps meet a requirement of the user for the navigation vehicle icon, to reduce times of creating the navigation vehicle icon, and helps reduce a quantity of three-dimensional navigation vehicle icons that needs to be maintained by the server, to reduce data storage pressure on the server.

Example 2: Adjustment of a surface texture of a three-dimensional navigation vehicle icon.

In some embodiments, the display style includes: a surface texture of the three-dimensional navigation vehicle icon; and operation 330 may be implemented as the following several operations.

Sub-operation 333-a: The terminal device displays at least one candidate surface texture, the candidate surface texture being generated based on an original surface texture of the three-dimensional navigation vehicle icon, and the original surface texture being configured for reflecting a surface material of the first object.

In some embodiments, the original surface texture is a surface texture determined according to the material images. The original surface texture is configured for simulating the surface material of the first object. In an embodiment, the original surface texture determined according to the material image is related to factors such as the surface material of the first object and ambient light when the material images are captured.

The foregoing original surface texture and the candidate surface texture are both one type of surface texture. The surface texture may be understood as a triangular grid. Each triangle in the triangular grid corresponds to a local region of a surface of the first object. A display effect of a triangle in a corresponding local region of the surface of the first object is determined based on a display effect (such as a color, a reflection effect, or a pattern) of the triangle. Exemplarily, the computer device can perform rendering on point cloud data of the first object based on the original surface texture, to generate a three-dimensional navigation vehicle icon.

The candidate surface texture is generated based on the original surface texture. In an embodiment, a form of a triangular grid corresponding to the candidate surface texture is the same as that of a triangular grid corresponding to the original surface texture. To be specific, for a first triangle at any position in the triangular grid corresponding to the candidate surface texture, a second triangle exists at a same position in the triangular grid corresponding to the original surface texture. A shape of the first triangle is the same as that of the second triangle, and a display effect of the first triangle is different from that of the second triangle.

In an example, the terminal device displays the three-dimensional navigation vehicle icon of the first object and the at least one candidate surface texture on a style adjustment interface.

Sub-operation 333-b: The terminal device displays, in response to an operation of selecting a first surface texture from the at least one candidate surface texture, a three-dimensional navigation vehicle icon having the first surface texture as the adjusted three-dimensional navigation vehicle icon, the adjusted three-dimensional navigation vehicle icon being generated by performing texture mapping on point cloud data of the first object based on the first surface texture.

In an embodiment, the operation of selecting the first surface texture from the at least one candidate surface texture is a click/tap operation, a slide operation, or the like for the first surface texture. For example, the operation of selecting the first surface texture from the at least one candidate surface texture is a click/tap operation, and the terminal device displays the adjusted three-dimensional navigation vehicle icon in response to the click/tap operation for the first surface texture.

Exemplarily, the adjusted three-dimensional navigation vehicle icon is generated by the computer device. After obtaining the operation of selecting the first surface texture, the terminal device transmits a texture adjustment request to the computer device. The computer device generates the adjusted three-dimensional navigation vehicle icon based on the texture adjustment request and transmits the adjusted three-dimensional navigation vehicle icon to the terminal device.

The texture adjustment request includes at least one of the following: an account identifier, a vehicle icon identifier, and a first texture identifier. The account identifier is configured for representing a first user account logged in to the terminal device, the vehicle icon identifier indicates the three-dimensional navigation vehicle icon of the first object, and the first texture identifier indicates the first surface texture.

In an embodiment, the computer device transmits the adjusted three-dimensional navigation vehicle icon to the server, and the server updates the three-dimensional navigation vehicle icon owned by the first user account. The server transmits the three-dimensional navigation vehicle icon to the terminal device.

The three-dimensional navigation vehicle icon generated by performing three-dimensional reconstruction based on the material images is limited by an actual material of the shot object, and the surface texture of the three-dimensional navigation vehicle icon is limited. The surface texture of the three-dimensional navigation vehicle icon is adjusted to generate the adjusted three-dimensional navigation vehicle icon, which enriches display effects of the texture of the three-dimensional navigation vehicle icon.

Example 3: Adjustment of a display size of a three-dimensional navigation vehicle icon.

In some embodiments, the display style includes a display size of the three-dimensional navigation vehicle icon on the navigation interface; and operation 330 may be implemented as the following sub-operations.

Sub-operation 335-a: The terminal device scales the display size of the three-dimensional navigation vehicle icon in response to an operation of adjusting the display size.

In some embodiments, the operation of adjusting the display size includes, but is not limited to, a slide operation, a key operation, a click/tap operation, or the like.

Exemplarily, the operation of adjusting the display size is that two fingers contact the terminal device, and the fingers slide, to change a linear distance between the two fingers. The terminal device zooms in the three-dimensional navigation vehicle icon if the linear distance between the two fingers increases; and the terminal device zooms out the three-dimensional navigation vehicle icon if the linear distance between the two fingers decreases.

Sub-operation 335-b: The terminal device displays the adjusted three-dimensional navigation vehicle icon in response to an operation of ending the adjustment of the display size.

Because a size of the shot object customized and selected by the user is not fixed, adjustment of the display size of the three-dimensional navigation vehicle icon helps reduce impact generated by introducing the three-dimensional navigation vehicle icon on a navigation process on the navigation interface. This helps prevent the three-dimensional navigation vehicle icon from blocking other navigation information on the navigation interface while providing a function of prompting a position of the three-dimensional navigation vehicle icon.

A process of performing post-processing on the three-dimensional navigation vehicle icon is described below by using several embodiments.

In some embodiments, after the terminal device displays the three-dimensional navigation vehicle icon of the first object, the method further includes: The terminal device displays a vehicle icon fusion interface, at least one decorative item being displayed on the vehicle icon fusion interface, and a three-dimensional model of the decorative item being preset; the terminal device displays a first decorative item at a first position in a surrounding box in response to an operation of selecting the first decorative item from the at least one decorative item, the surrounding box being virtual three-dimensional space surrounding the three-dimensional navigation vehicle icon; and the terminal device displays a fused three-dimensional navigation vehicle icon in response to an operation of ending vehicle icon fusion, the fused three-dimensional navigation vehicle icon being obtained by fusing at least one three-dimensional model included in the surrounding box, and the fused three-dimensional navigation vehicle icon being displayed on the navigation interface.

In some embodiments, the vehicle icon fusion interface is an interface that implements fusion of the three-dimensional navigation vehicle icon and the decorative item. In an embodiment, the decorative item has a three-dimensional structure, and the three-dimensional model of the decorative item is known. Exemplarily, the three-dimensional model of the decorative item is a dynamic three-dimensional model, that is, a display style of the decorative item changes.

In an embodiment, a type of the decorative item includes, but is not limited to, at least one of the following: a plant, an animal, a virtual vehicle, a garment, and the like. Exemplarily, the type of the decorative item displayed on the vehicle icon fusion interface is related to a type of the first object. For example, if the first object is a person, the at least one decorative item displayed on the vehicle icon fusion interface includes a virtual vehicle, a garment, or the like. For another example, if the first object is a static object, the at least one decorative item displayed on the vehicle icon fusion interface includes a plant, an animal, or the like.

After obtaining the material images, the computer device identifies the image in the material images through a type identification model, to determine the type of the first object. After completing the creation of the three-dimensional navigation vehicle icon of the first object, the computer device transmits the three-dimensional navigation vehicle icon and the type of the first object to the server. The server determines the at least one decorative item according to the type of the first object. The server transmits decorative item information to the terminal device after the terminal devices enters the vehicle icon fusion interface. The terminal device displays the at least one decorative item on the vehicle icon fusion interface according to the decorative item information. The decorative item information includes a display style of the at least one decorative item.

In some embodiments, the surrounding box is a three-dimensional space region centered on the three-dimensional navigation vehicle icon. The three-dimensional navigation vehicle icon is located inside the surrounding box. In an embodiment, the first position refers to any position in the surrounding box. Exemplarily, the first position does not overlap with a position of the three-dimensional navigation vehicle icon in the surrounding box.

In an embodiment, the operation of selecting the first decorative item from the at least one decorative item includes, but is not limited to, a click/tap operation, a slide operation, a key operation, a gesture operation, or the like. The operation of selecting the first decorative item from the at least one decorative item is briefly referred to as an operation of selecting the first decorative item.

Exemplarily, the terminal device determines, in response to a click/tap operation for the first decorative item, to select the first decorative item to be fused with the three-dimensional navigation vehicle icon. The terminal device determines the position of the three-dimensional navigation vehicle icon in the surrounding box, and determines the first position based on the position of the three-dimensional navigation vehicle icon in the surrounding box. The terminal device displays the first decorative item at the first position in the surrounding box.

In some embodiments, the operation of ending vehicle icon fusion instructs fusing the first decorative item and the three-dimensional navigation vehicle icon, to generate a fused three-dimensional navigation vehicle icon. In an embodiment, a fusion confirmation control is displayed on the vehicle icon fusion interface, and the operation of ending vehicle icon fusion is an operation of triggering the fusion confirmation control. For example, the fusion confirmation control is clicked/tapped.

In some embodiments, the fused three-dimensional navigation vehicle icon includes the three-dimensional navigation vehicle icon and the first decorative item. In an embodiment, in a process of displaying the fused three-dimensional navigation vehicle icon on the navigation interface, a relative distance between the three-dimensional navigation vehicle icon and the first decorative item does not change.

The three-dimensional navigation vehicle icon generated according to the material images is a static three-dimensional model. The decorative item is fused with the three-dimensional navigation vehicle icon, which makes the three-dimensional navigation vehicle icon more dynamic, and helps improve a prompting capability of the fused three-dimensional navigation vehicle icon on the navigation interface. In addition, the three-dimensional navigation vehicle icon is created first, and then the fused three-dimensional navigation vehicle icon is generated. The fused three-dimensional navigation vehicle icon is generated in operations, which helps reduce calculation overheads of the computer device compared with direct generation of the three-dimensional navigation vehicle icon in one operation.

The embodiment of generating the fused three-dimensional navigation vehicle icon and the embodiment of adjusting the display style of the three-dimensional navigation vehicle icon may be freely combined.

For example, after displaying the three-dimensional navigation vehicle icon, the terminal device first adjusts the display style of the three-dimensional navigation vehicle icon, to generate the adjusted three-dimensional navigation vehicle icon, and then fuses the adjusted three-dimensional navigation vehicle icon with the first decorative item, to obtain the fused three-dimensional navigation vehicle icon.

For another example, after displaying the three-dimensional navigation vehicle icon, the terminal device first fuses the three-dimensional navigation vehicle icon with the first decorative item, to obtain the fused three-dimensional navigation vehicle icon, and adjusts the display style of the fused three-dimensional navigation vehicle icon, to obtain the adjusted three-dimensional navigation vehicle icon.

In an example, the process of creating the three-dimensional navigation vehicle icon includes the following several operations.

Operation A10: A terminal device displays material images of a first object on an image capture interface in response to an operation of capturing images. The terminal device displays a three-dimensional navigation vehicle icon of the first object.

Operation A20: The terminal device displays at least one candidate surface texture, and displays an adjusted three-dimensional navigation vehicle icon in response to an operation of selecting a first surface texture from the at least one candidate surface texture.

In an embodiment, after completing an operation of adjusting a style, the terminal device displays a fusion initiation control.

Operation A30: The terminal device displays a vehicle icon fusion interface, at least one decorative item being displayed on the vehicle icon fusion interface. In an embodiment, the terminal device displays the vehicle icon fusion interface in response to an operation of triggering the fusion initiation control.

Operation A40: The terminal device displays a first decorative item at a first position in a surrounding box in response to an operation of selecting the first decorative item, the surrounding box being virtual three-dimensional space surrounding the adjusted three-dimensional navigation vehicle icon.

Operation A50: The terminal device displays a fused three-dimensional navigation vehicle icon in response to an operation of ending vehicle icon fusion, the fused three-dimensional navigation vehicle icon being obtained by fusing at least one three-dimensional model included in the surrounding box.

In an embodiment, after obtaining the fused three-dimensional navigation vehicle icon, the terminal device closes an entry for adjusting a display style of the fused three-dimensional navigation vehicle icon. To be specific, after the fused three-dimensional navigation vehicle icon is generated, the user no longer adjusts the display style of the fused three-dimensional navigation vehicle icon.

For specific content of the operations in this embodiment, refer to the foregoing embodiments. Details are not described here again. Compared with the fused three-dimensional navigation vehicle icon, the three-dimensional navigation vehicle icon has a simpler form. Therefore, the terminal device is controlled to first adjust the display style and then perform vehicle icon fusion, which helps reduce time consumption of a procedure.

The following describes a process of using the three-dimensional navigation vehicle icon by using an embodiment.

In some embodiments, the process of using the three-dimensional navigation vehicle icon further includes: The terminal device displays the three-dimensional navigation vehicle icon on the navigation interface; and the terminal device adjusts a position and a posture of the three-dimensional navigation vehicle icon on the navigation interface according to a position and a posture of the terminal device in the real-world environment.

In an embodiment, the posture of the terminal device in the real-world environment is configured for representing a bearing of the terminal device in the real-world environment. Exemplarily, if the terminal device moves to the north, the bearing of the terminal device in the real-world environment is the north. In an embodiment, a navigation map is displayed on the navigation interface, and the three-dimensional navigation vehicle icon is displayed on the navigation map, to reflect the position of the terminal device in the real-world environment.

The position of the three-dimensional navigation vehicle icon on the navigation interface may be understood as a position of the three-dimensional navigation vehicle icon on the navigation map. The position of the three-dimensional navigation vehicle icon on the navigation interface corresponds to the position of the terminal device in the real-world environment.

The posture of the three-dimensional navigation vehicle icon includes the bearing of the three-dimensional navigation vehicle icon, and the posture of the three-dimensional navigation vehicle icon indicates a change direction of the position of the three-dimensional navigation vehicle icon on the navigation interface.

In an embodiment, the navigation interface supports displaying up to t three-dimensional navigation vehicle icons, where t is a positive integer. The t three-dimensional navigation vehicle icons respectively correspond to different terminal devices. For an i^{th} three-dimensional navigation vehicle icon in the t three-dimensional navigation vehicle icons, a position and a posture of the i^{th} three-dimensional navigation vehicle icon on the navigation interface are related to a position and a posture of an i^{th} terminal device corresponding to the i^{th} three-dimensional navigation vehicle icon in the real-world environment.

The solution of displaying three-dimensional navigation vehicle icons corresponding to other terminal devices on the navigation interface requires authorization from users of the other devices and can only be implemented if it complies with local laws and regulations. This function is only applied to a scenario of convoy travel, wherein a team needs to reach a same destination together, for avoiding a vehicle gets lost.

In an embodiment, in a case in which t terminal devices respectively input a same destination into the navigation application program, and the t terminal devices perform mutual authorization, the t three-dimensional navigation vehicle icons can be displayed on the navigation interface. Exemplarily, in this case, a vehicle icon sharing identifier is displayed on the navigation interface, and the vehicle icon sharing identifier prompts display of the three-dimensional navigation vehicle icon on a navigation interface of another terminal device. Exemplarily, an authorization request is displayed on the navigation interface at a second time interval. The terminal device allows, in response to an operation of agreeing to the authorization request, another terminal device to continue to display the three-dimensional navigation vehicle icon corresponding to the terminal device on the navigation interface. The terminal device transmits a rejection prompt to the server in response to an operation of rejecting the authorization request. The server no longer transmits position change information of the three-dimensional navigation vehicle icon of the terminal device on the navigation interface to the another device according to the rejection prompt. In this way, a function of sharing the vehicle icon on the navigation interface may be disabled in time according to an actual requirement.

The following describes a three-dimensional navigation vehicle icon method on a terminal device side by using an overall embodiment. An execution body of this embodiment is a terminal device such as a target client in the terminal device. This embodiment may include the following operations.

Operation B10: Display an icon selection interface, a first capture entry being displayed on the icon selection interface, the icon selection interface being configured for managing at least one three-dimensional navigation vehicle icon, and the first capture entry being configured for capturing material images; and display an image capture interface in response to an operation of triggering the first capture entry.

In an embodiment, the first capture entry may be implemented as a banner on the icon selection interface.

In some embodiments, the terminal device displays the image capture interface in response to the operation of triggering the first capture entry, including: displaying a vehicle icon production interface in response to the operation of triggering the first capture entry, a first control and a second control being displayed on the vehicle icon production interface; and displaying, by the terminal device, the image capture interface in response to an operation of triggering the second control. The first control is configured to display a vehicle icon owning interface, the vehicle icon owning interface is configured for displaying a three-dimensional navigation vehicle icon owned by a first user account logged in to the terminal device, and the second control is configured for displaying an image capture control.

In some embodiments, before the terminal device displays the image capture interface, the method further includes: displaying sixth prompt information in response to that/when the first user account satisfies a user condition. The sixth prompt information is configured for requesting authorization for a process of capturing the material images. Exemplarily, the sixth prompt information is displayed in a form of a pop-up window.

In an embodiment, the user condition includes: the first user account enters the image capture interface for the first time, or the first user account does not enter the image capture interface for the first time but does not grant a target application permission to capture the material images. The terminal device displays the sixth prompt information in response to that/when the first user account does not satisfy the user condition.

In some embodiments, before the displaying the image capture interface, the method further includes: displaying seventh prompt information in response to that/when the first user account satisfies the user condition. The seventh prompt information prompts the three-dimensional navigation vehicle icon method.

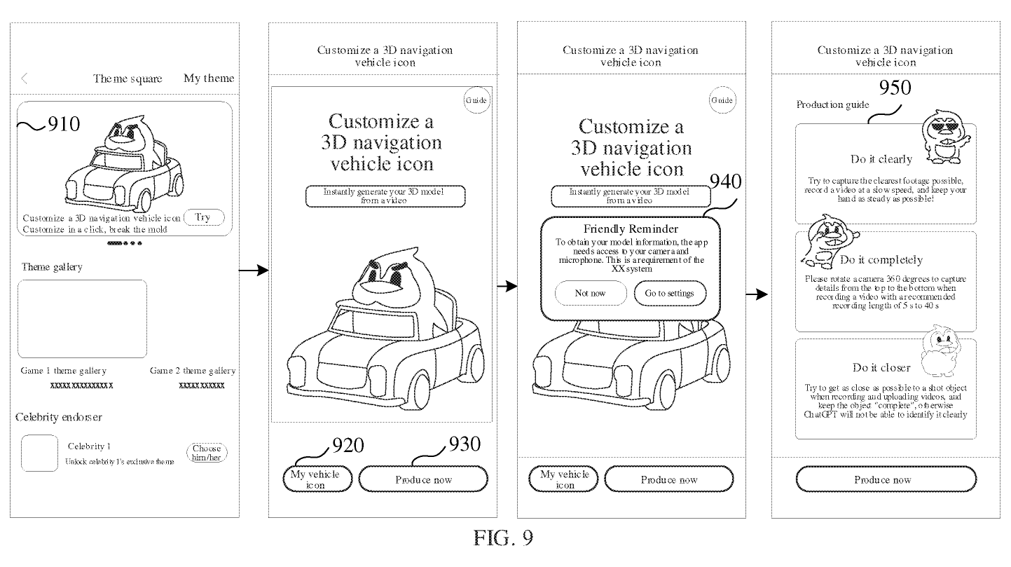

FIG. 9 is a schematic diagram of an interface before entering an image capture interface according to an exemplary embodiment of the present disclosure.

The terminal device enters a vehicle icon production interface through a first capture entry 910, and a first control 920 and a second control 930 are displayed on the vehicle icon production interface. The terminal device displays an image capture interface in response to an operation of triggering the second control 930. Sixth prompt information 940 and seventh prompt information 950 are displayed in response to that/when the first user account satisfies the user condition.

Operation B20: Display an image capture control on the image capture interface; and display, on the image capture interface in response to an operation of triggering the image capture control, a field-of-view image of a process in which a camera captures the first object.

Operation B30: Display first prompt information on a top layer of the field-of-view image, the first prompt information prompting a recommended movement trajectory for the camera to shoot the first object.

Operation B40: Display material images of the first object on the image capture interface in response to an operation of capturing images.

Operation B50: Display second prompt information in response to an operation of performing three-dimensional reconstruction on the first object; or display the second prompt information in response to that/when a data volume of the material image reaches a data volume upper limit value and the operation of performing three-dimensional reconstruction on the first object is not received.

Operation B55: Display identifier information of a three-dimensional navigation vehicle icon in response to an operation of setting the identifier information, the identifier information being configured for uniquely identifying the three-dimensional navigation vehicle icon. The operation (such as operation 310) of displaying the three-dimensional navigation vehicle icon of the first object is performed in response to that/when the identifier information of the three-dimensional navigation vehicle icon conforms to a naming rule and the material images conform to a content rule.

Operation B60: Update the second prompt information at a first time interval if remaining creation duration is greater than the first time interval, and display updated second prompt information until the creation of the three-dimensional navigation vehicle icon is completed.

Operation B70: Display the three-dimensional navigation vehicle icon of the first object.

Operation B80: Display a vehicle icon fusion interface, at least one decorative item being displayed on the vehicle icon fusion interface, and a three-dimensional model of the decorative item being preset; display a first decorative item at a first position in a surrounding box in response to an operation of selecting the first decorative item; and display a fused three-dimensional navigation vehicle icon in response to an operation of ending vehicle icon fusion.

Operation B90: Display an adjusted three-dimensional navigation vehicle icon in response to an operation of adjusting a display style of the three-dimensional navigation vehicle icon.

Operation B100: The terminal device displays the three-dimensional navigation vehicle icon on a navigation interface; and the terminal device adjusts a position and a posture of the three-dimensional navigation vehicle icon on the navigation interface according to a position and a posture of the terminal device in a real-world environment.

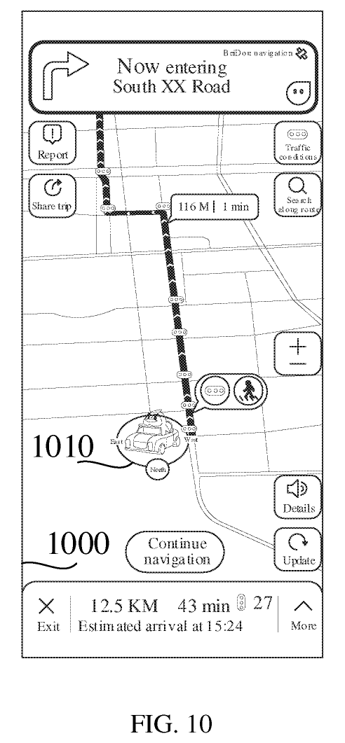

FIG. 10 is a schematic diagram of a navigation interface according to an exemplary embodiment of the present disclosure.

As shown in FIG. 10, a three-dimensional navigation vehicle icon 1010 is displayed on a navigation interface 1000.

For content not described in this embodiment in detail, refer to the foregoing embodiments.

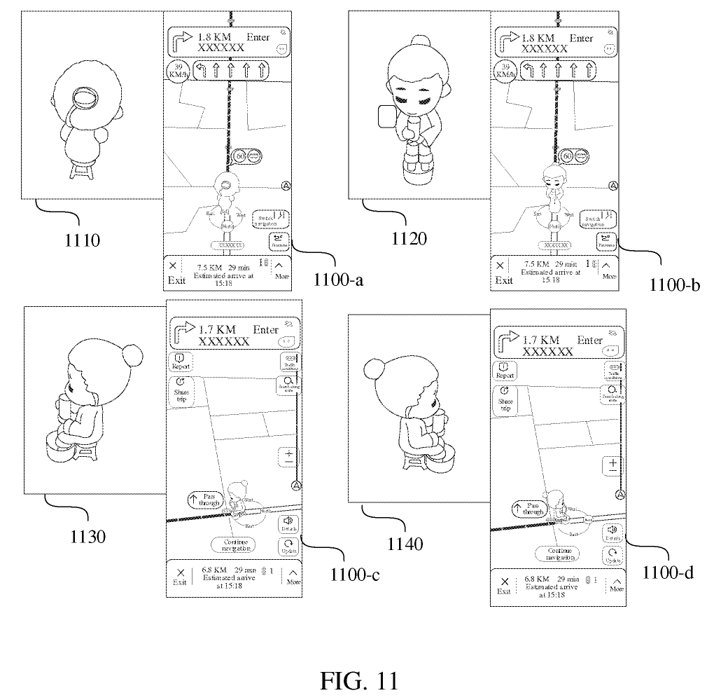

FIG. 11 is a schematic diagram of a display effect of a three-dimensional navigation vehicle icon according to an exemplary embodiment of the present disclosure.

When the three-dimensional navigation vehicle icon is in a first orientation 1110, a display style of the three-dimensional navigation vehicle icon on the navigation interface is 1100-a. When the three-dimensional navigation vehicle icon is in a second orientation 1120, a display style of the three-dimensional navigation vehicle icon on the navigation interface is 1100-b. When the three-dimensional navigation vehicle icon is in a third orientation 1130, a display style of the three-dimensional navigation vehicle icon on the navigation interface is 1100-c. When the three-dimensional navigation vehicle icon is in a fourth orientation 1140, a display style of the three-dimensional navigation vehicle icon on the navigation interface is 1100-d.

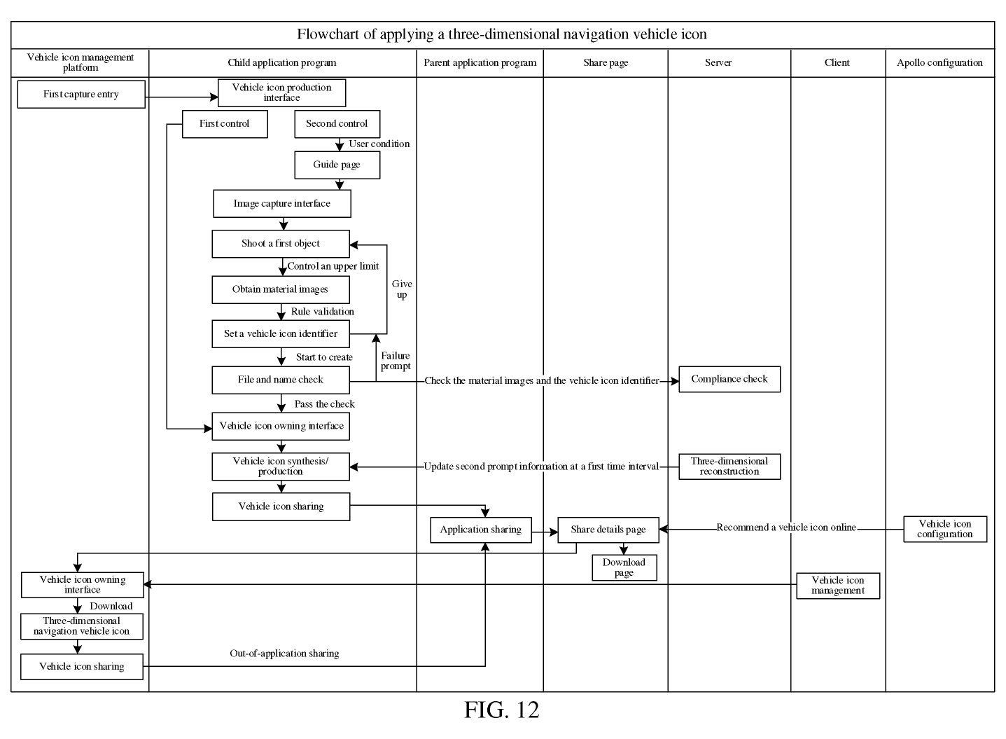

FIG. 12 is an interaction diagram of a vehicle icon application process according to an exemplary embodiment of the present disclosure.

In some examples, the three-dimensional navigation vehicle icon creation method provided in the present disclosure relates to a plurality of platforms, primarily including a vehicle icon management platform (also referred to as a theme square), a child application program (namely, a target application program), a parent application program, a share page (H5) and a client, a server (including a computer device), an Apollo configuration, and the like.

The vehicle icon management platform is a primary entry for creating a three-dimensional navigation vehicle icon and managing a three-dimensional navigation vehicle icon owned by a user account. The vehicle icon management platform is configured to provide a first capture entry for a user.

The child application program refers to the target application program in the foregoing embodiments, and is configured for obtaining material images that are configured for customizing a three-dimensional navigation vehicle icon. As described in the foregoing embodiments, a terminal device displays a vehicle icon production interface in response to an operation of triggering the first capture entry. A first control and a second control are displayed on the vehicle icon production interface. In response to that/when a three-dimensional navigation vehicle icon needs to be created, the user triggers the second control.

The terminal device displays an image capture interface in response to an operation of triggering the second control. In an embodiment, before displaying the image capture interface, the terminal device determines whether the first user account enters the image capture interface for the first time. If the first user account enters the image capture interface for the first time, the terminal device displays sixth prompt information and seventh prompt information (also referred to as a strategy page) in a form of a pop-up window.

The terminal device displays the image capture interface in response to that/when the first user account does not satisfy a user condition, and obtains material images of a first object in response to an operation for an image capture control. When the material images are a video, the first object may be shot in real time on the image capture interface. In a shooting process, the terminal device displays first prompt information in a field-of-view image. The first prompt information prompts at least one of the following: a recommended shooting trajectory for shooting the first object, and a recommended position of the first object in the image.

In an embodiment, in the process of shooting the first object, fourth prompt information is further displayed on the image capture interface. The fourth prompt information is configured for representing maximum remaining shooting duration. The fourth prompt information may be a countdown initiated upon shooting the first object and counting down from the maximum shooting duration.

When the maximum remaining shooting duration is equal to 0 or an operation of performing three-dimensional reconstruction on the first object performed by the user is obtained, the terminal device uses the shot video as the material images. The terminal device transmits the material images to a server, and the server performs a compliance check on the material images.

Subsequently, the terminal device displays identifier information of a vehicle icon of the three-dimensional navigation in response to an operation of setting the identifier information. The terminal device transmits the identifier information of the three-dimensional navigation vehicle icon to the server, and the server performs a compliance check on the identifier information of the three-dimensional navigation vehicle icon.

In response to that/when the identifier information of the three-dimensional navigation vehicle icon conforms to a naming rule, the terminal device displays a failure prompt, to prompt the user to input the identifier information of the three-dimensional navigation vehicle icon again. In response to that/when the identifier information of the three-dimensional navigation vehicle icon conforms to the naming rule and the material images conform to a content rule, the server transmits the material images to a computer device, the computer device performs three-dimensional reconstruction based on the material images, to generate the three-dimensional navigation vehicle icon.

In a process in which the computer device completes the creation of the three-dimensional navigation vehicle icon, the terminal device displays second prompt information. The second prompt information is configured for representing remaining creation duration of the three-dimensional navigation vehicle icon. The terminal device may update the second prompt information at a first time interval. After the creation of the three-dimensional navigation vehicle icon is completed, the terminal device displays the three-dimensional navigation vehicle icon.

After the three-dimensional navigation vehicle icon is created, the terminal device supports adjusting a display style of the three-dimensional navigation vehicle icon in response to a user operation, and performing fusion on the three-dimensional navigation vehicle icon. For specific content of this operation, refer to the foregoing embodiments. Details are not described herein again.

After the first user account creates the three-dimensional navigation vehicle icon, the first user account is supported to perform social sharing on the three-dimensional navigation vehicle icon. This function may be jointly completed by the child application program and the parent application program.

The parent application program primarily undertakes login of a user account. In addition, the target application program further undertakes functions of twice viewing, by an external terminal, content of a detail page of a three-dimensional navigation vehicle icon, and sharing the three-dimensional navigation vehicle icon between different accounts.

The server is configured to synchronize account information; and completes a compliance check. Both the captured materials that are captured and uploaded by the terminal device and the identifier information of the three-dimensional navigation vehicle icon need to be subjected to a compliance check, to ensure that a production process can be performed only when the captured materials and the identifier information of the three-dimensional navigation vehicle icon conform to the laws and regulations.

In some embodiments, after the terminal device displays the three-dimensional navigation vehicle icon of the first object, the three-dimensional navigation vehicle icon creation method further includes: displaying a first navigation vehicle icon and a second navigation vehicle icon in response to an operation of obtaining the first navigation vehicle icon and the second navigation vehicle icon, the first navigation vehicle icon being a three-dimensional navigation vehicle icon, and the second navigation vehicle icon being a three-dimensional navigation vehicle icon; and displaying a combined navigation vehicle icon in response to an operation of combining vehicle icons, the combined navigation vehicle icon being obtained by combining the first navigation vehicle icon and the second navigation vehicle icon, and the combined navigation vehicle icon being displayed on the navigation interface.

In an embodiment, the first navigation vehicle icon is created by a first user account logged in to the target application program on the terminal device (referred to as a first terminal in this embodiment), and the second navigation vehicle icon is created by the first user account logged in to the target application program on another terminal device (referred to as a second terminal in this embodiment).

In an embodiment, the displaying, by the first terminal, the first navigation vehicle icon and the second navigation vehicle icon in response to the operation of obtaining the first navigation vehicle icon and the second navigation vehicle icon includes: receiving, by the first terminal, vehicle icon providing information transmitted by the second terminal, the vehicle icon providing information being configured for authorizing the first terminal to obtain the second navigation vehicle icon; transmitting, by the first terminal, a vehicle icon obtaining request to the server according to the vehicle icon providing information; and receiving, by the terminal device, the second navigation vehicle icon transmitted by the server according to the vehicle icon obtaining request.

The vehicle icon providing information includes: an identifier of the second terminal and identifier information of the second navigation vehicle icon.

In some embodiments, the displaying, by the first terminal, a combined navigation vehicle icon in response to an operation of combining vehicle icons includes: generating, by the first terminal, a vehicle icon combination request in response to the operation of combining the vehicle icons, and transmitting the vehicle icon combination request to the server, the vehicle icon combination request including identifier information of the first navigation vehicle icon, the identifier information of the second navigation vehicle icon, and an offset position of the first navigation vehicle icon relative to the second navigation vehicle icon. The server transmits a vehicle icon combination instruction to the computer device when determining, according to the vehicle icon combination request, that the first navigation vehicle icon and the second navigation vehicle icon are allowed to be combined, and the computer device places the first navigation vehicle icon and the second navigation vehicle icon in the same virtual space according to the vehicle icon combination instruction, to obtain the combined navigation vehicle icon.

Exemplarily, the vehicle icon combination instruction includes: the identifier information of the first navigation vehicle icon, the identifier information of the second navigation vehicle icon, and the offset position of the first navigation vehicle icon relative to the second navigation vehicle icon.

The server estimates a volume of the combined navigation vehicle icon according to the offset position of the first navigation vehicle icon relative to the second navigation vehicle icon. In an embodiment, if the volume of the combined navigation vehicle icon is less than or equal to a volume upper limit, the server determines that the first navigation vehicle icon and the second navigation vehicle icon are allowed to be combined. If the volume of the combined navigation vehicle icon volume is greater than the volume upper limit, the server determines that the first navigation vehicle icon and the second navigation vehicle icon are not allowed to be combined. The volume upper limit is preset, and is configured for controlling the volume of the combined navigation vehicle icon, to prevent the combined navigation vehicle icon displayed on the navigation interface from blocking traffic condition information on the navigation interface.

Exemplarily, after receiving the vehicle icon providing information transmitted by the second terminal, the first terminal displays the second navigation vehicle icon on the navigation interface in response to an operation of applying the second navigation vehicle icon, that is, directly uses the three-dimensional navigation vehicle icon created by the second terminal. It is convenient for different users to share the three-dimensional navigation vehicle icon.

A three-dimensional navigation vehicle icon is generated based on material images. Material images captured by different users are limited. By the foregoing method, three-dimensional navigation vehicle icons obtained by a plurality of users are supported to be combined. After the three-dimensional navigation vehicle icons are created, a function of combining the three-dimensional navigation vehicle icons is provided, which reduces a requirement for the material images. Moreover, the combined navigation vehicle icon is generated from the three-dimensional navigation vehicle icons, which provides more available three-dimensional navigation vehicle icons for the user, and helps improve richness of the three-dimensional navigation vehicle icons.

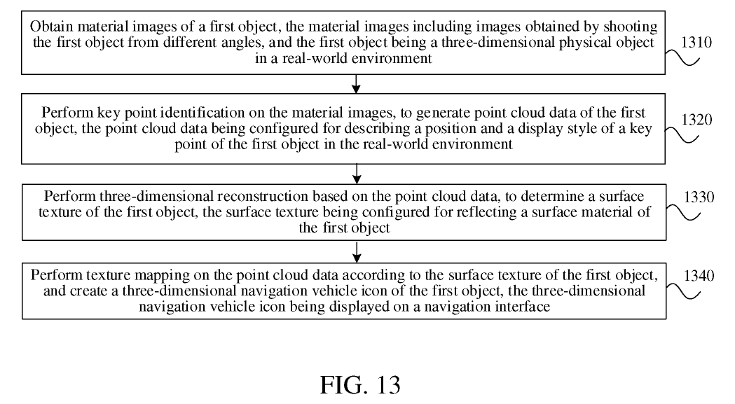

FIG. 13 is a flowchart of a three-dimensional navigation vehicle icon creation method according to another exemplary embodiment of the present disclosure. Exemplarily, an execution body of the method may be the computer device 30 in FIG. 1. The following describes the three-dimensional navigation vehicle icon creation method by using a computer device as the execution body. As shown in FIG. 13, the method may include the following operations (1310 to 1340).

Operation 1310: Obtain material images of a first object, the material images including images obtained by shooting the first object from different angles, and the first object being a three-dimensional physical object in a real-world environment.

In some embodiments, the material images are transmitted by a terminal device to the computer device. In some other embodiments, the material images are searched and downloaded by the computer device from the Internet. For specific introduction about the material images and the first object, refer to the terminal device side embodiments. Details are not described herein again.

Operation 1320: Perform key point identification on the material images, to generate point cloud data of the first object, the point cloud data being configured for describing a position and a display style of a key point of the first object in the real-world environment.

In some embodiments, the key point is configured for representing a surface contour of the first object. In other words, the key point refers to a point on a surface of the first object. In an embodiment, the key point includes at least one of the following: an edge point of a contour of the first object, a color within the contour of the first object, or a point on a boundary at which a relatively large fluctuation occurs in a shape. The key point is also referred to as a feature point. Exemplarily, the key point may be determined according to a variation area of a pixel value of a pixel in the image. For example, a key point is an extremum point of a pixel change in the image.

In some embodiments, the point cloud data refers to a data set about the key point, and the point cloud data is configured for reconstructing the first object in virtual three-dimensional space.

In an embodiment, the point cloud data includes position information of the key point and photometric information of the key point. The position information indicates three-dimensional coordinates of the key point, and the photometric information is configured for representing a color of the key point and a capability of refracting and reflecting light.

Operation 1330: Perform three-dimensional reconstruction based on the point cloud data, to determine an original surface texture of the first object, the original surface texture being configured for reflecting a surface material of the first object.

In this embodiment, the original surface texture of the first object is the original surface texture mentioned in the foregoing embodiments. For specific introduction about the original surface texture, refer to the foregoing embodiments. Details are not described here again.

Operation 1340: Perform texture mapping on the point cloud data according to the surface texture of the first object, and create a three-dimensional navigation vehicle icon of the first object, the three-dimensional navigation vehicle icon being displayed on a navigation interface. In some implementations, Operation 1340 may include a portion or all of the following: perform texture mapping on the point cloud data according to the surface texture of the first object; and/or create a three-dimensional navigation vehicle icon of the first object for being displayed on a navigation interface. In some implementations, Operation 1340 may further include displaying the three-dimensional navigation vehicle icon of the first object on the navigation interface.

In some embodiments, the computer device renders the point cloud data based on the surface texture, to obtain the three-dimensional navigation vehicle icon of the first object. After generating the three-dimensional navigation vehicle icon of the first object, the computer device transmits the three-dimensional navigation vehicle icon of the first object to the server, and the server forwards the three-dimensional navigation vehicle icon of the first object to the terminal device.

In conclusion, compared with the related technology in which a skilled person needs to generate a 3D skeletal vehicle icon, in the embodiments of the present disclosure, the computer device performs three-dimensional reconstruction based on the material images of the shot object, to generate the three-dimensional navigation vehicle icon of the shot object, which helps reduce production costs of the three-dimensional navigation vehicle icon, and helps shorten a generation period of the three-dimensional navigation vehicle icon. In this way, the three-dimensional navigation vehicle icon is obtained more conveniently and quickly, which helps meet requirements for updating and iterating the three-dimensional navigation vehicle icon.

In addition, in this method, the computer device creates the three-dimensional navigation vehicle icon in a cloud. In this way, a mobile terminal has a capability of generating the three-dimensional navigation vehicle icon, which helps improve convenience of the process of creating the three-dimensional navigation vehicle icon.

The following introduces and explains a process of determining the point cloud data by using several embodiments.

In some embodiments, operation 1320 of performing key point identification on the material images, to determine (or generate) point cloud data of the first object includes the following sub-operations.

Sub-operation 1321: The computer device performs key point identification on a plurality of images in the material images, to separately determine key point information of each image, the key point information including a descriptor of the key point, and the descriptor is configured for representing a local structural feature of the key point in the image.

In some embodiments, the plurality of images in the material images are a plurality of images selected from the material images. For example, when the material images belong to a video, any two adjacent images in the plurality of images are two video frames apart by k frames in the video, where k is a positive integer. In an embodiment, the computer device selects an image from the video at an interval of k consecutive image frames, to obtain the plurality of images. The computer device performs three-dimensional reconstruction based on the plurality of images.

For images captured from consecutive shooting angles, such as two consecutive video frames in a video, information amounts included in the two consecutive video frames greatly overlap. Some images are selected from the material images, to reduce overlap between information amounts respectively included in the images. Subsequently, the computer device performs three-dimensional reconstruction based on the images, which helps reduce a calculation amount of generating the three-dimensional navigation vehicle icon.

In some embodiments, the descriptor is configured for representing a visual feature of the key point in an area to which the key point belongs in the image. The visual feature includes a shape feature and a texture feature in the area to which the key point belongs. The shape feature is configured for representing a shape of a local region around the key point of the first object, and the texture feature is configured for representing a texture of the local region around the key point of the first object. In an embodiment, the descriptor is represented in a form of a vector. Vector dimensions of descriptors of a plurality of keys included in the image are equal.

In some embodiments, the computer device performs key point identification on the plurality of images in the material images, to separately determine the key point information of each image, including: the computer device performs, for each of the plurality of images, at least one blurring and downsampling on the image, to obtain a Gaussian image set, the Gaussian image set including a plurality of Gaussian image groups, and the Gaussian image group including Gaussian images with different blurring degrees; the computer device separately performs, for each Gaussian image group, differential processing on every two adjacent Gaussian images in the Gaussian image group, to obtain a differential image group; the computer device determines at least one extremum point based on a pixel value change trend of a pixel in at least one differential image in the differential image group; and the computer device establishes an extremum point change curve based on the at least one extremum point, to determine at least one key point of the first object, and determines key point information of the image according to the at least one key point and the Gaussian image set.

In some embodiments, for any of the plurality of images, the computer device generates a Gaussian pyramid of the image. Blurring refers to processing a pixel in an image by using a Gaussian kernel. The Gaussian kernel is configured to perform fusion (such as averaging) on pixel values of pixels in an area, to obtain a fused pixel value. In this way, after the fusion, a value of each pixel in the area is equal to the fused pixel value.

In an embodiment, the Gaussian image set is referred to as a Gaussian pyramid, and the plurality of Gaussian image groups has a hierarchical structure in the Gaussian pyramid. A Gaussian image in a Gaussian image group on a higher layer has a smaller size and a higher blur degree. The Gaussian image group on a lowest layer of the hierarchical structure includes the image or an upsampled image obtained after upsampling is performed on the image. Upsampling is configured for scaling up a size of an image, and downsampling is configured for scaling down a size of an image.

In an embodiment, the differential image is obtained by performing differential processing on two Gaussian images having similar blurring degrees in a same Gaussian image group. Differential processing may be implemented as subtraction of pixel values at corresponding positions in two Gaussian images.

Exemplarily, the computer device performs a subtraction operation on two adjacent Gaussian images in a same Gaussian image group, to obtain a differential image. For a first Gaussian image group in the plurality of Gaussian image groups, it is assumed that the first Gaussian image group includes x Gaussian images, a first differential image group determined according to the first Gaussian image group includes x-1 differential images, where x is a positive integer greater than 1.

In some embodiments, the computer device establishes an extremum point change curve based on the at least one extremum point, to determine at least one key point of the first object, including: The computer device performs Taylor expansion based on the at least one extremum point, and generates the extremum point change curve through fitting, the extremum point change curve including the at least one extremum point; the computer device performs derivation on the extremum point curve to determine at least one continuous extremum point; and the computer device uses the continuous extremum point as the key point.

Because pixels in the image are discrete, determining the key point based on the extremum point change curve helps improve accuracy of identifying the key point in the image, and helps improve similarity between the generated three-dimensional navigation vehicle icon and the shot object.

In some embodiments, the computer device determines the key point information of the image according to the at least one key point and the Gaussian image set, including: The computer device determines, for each of the at least one key point, an associated area of the key point in a Gaussian image corresponding to the key point, the Gaussian image corresponding to the key point being a Gaussian image in the Gaussian image set whose blur degree is closest to a blur degree of a differential image corresponding to the key point, and the key point being a center point in the associated area; the computer device counts gradient magnitudes of pixels included in the associated area, and determines a direction with a maximum gradient magnitude as a main direction of the key point; the computer device performs, based on the main direction of the key point, coordinate system conversion on the Gaussian image corresponding to the key point, to obtain an adjusted Gaussian image; and the computer device counts, in the adjusted Gaussian image, gradient magnitudes of pixels within a first radius area that uses the key point as a circle center, to obtain the descriptor of the key point.

In an embodiment, the differential image corresponding to the key point refers to a differential image determined based on the key point.

In an embodiment, the computer device determines the descriptor of the key point based on a Scale Invariant Feature Transform (SIFT) algorithm, that is, obtains key point information.

Sub-operation 1323: The computer device determines camera parameters according to the key point information of the image, the camera parameters including an intrinsic camera parameter and an extrinsic camera parameter that are configured for capturing the material images.

In some embodiments, the computer device determines camera parameters according to the key point information of the image, including:

The computer device determines at least one key point chain according to key point information of a plurality of images, the key point chain being configured for representing changes of shooting positions of the plurality of images; the computer device performs parameter estimation according to the at least one key point chain, to determine initial parameters; and the computer device performs joint optimization on the at least one key point and the initial parameters, to obtain the camera parameters.

In an embodiment, the camera parameters include: the intrinsic camera parameter and the extrinsic camera parameter. The intrinsic camera parameter includes: a focal length and a principal point. The extrinsic camera parameter includes a camera position and a camera rotation angle.

In some embodiments, the computer device determines at least one key point chain according to key point information of a plurality of images, including: The computer device performs, for each original image group in the material images, similarity matching on key point information of a first image and key point information of a second image in the original image group, to obtain at least one group of matching points, a difference between a shooting angle of the first image and a shooting angle of the second image being less than or equal to a first threshold; the computer device deletes a noise point from the at least one group of matching points, to obtain at least one key point group; and the computer device performs similarity matching on key point groups of the material images, to determine the at least one key point chain, the key point groups of the material images including key point groups of original image groups.

In an embodiment, the computer device determines the at least one key point chain based on sequential matching. Specifically, the computer device performs similarity matching on adjacent images, to obtain at least one matching point group. The computer device may delete the noise point from the at least one group of matching points by using a random sample consensus (RANSAC) algorithm, and the noise point is fitted by the least squares method. Subsequently, the computer device performs continuous frame matching, to generate and determine the at least one key point chain.

In an embodiment, the computer device determines to perform parameter estimation according to the key point chain, to obtain the initial parameters, and the computer device performs joint optimization on the position information of the key point and the camera parameters through Bundle Adjustment (BA). Specifically, the computer device estimates a re-projection error according to the initial parameters and the position information of the key point. The computer device calculates a residual according to the re-projection error, and constructs a linear equation system based on the residual and reciprocals of the camera parameters and the position information of the key point. The camera parameters and the position information of the key point are updated by solving the linear equation system for increments.

Sub-operation 1325: The computer device determines point cloud data of the first object according to the camera parameters.

In some embodiments, the point cloud data includes the position information of the key point and photometric information of the key point. The position information of the key point is determined according to the camera parameters and the material images, and the photometric information is configured for representing a display style of the key point. The computer device determines point cloud data of the first object according to the camera parameters, including: The computer device generates, for a third image in the material images, a reconstructed image based on the third image and the camera parameters through a scene reconstruction network; the computer device adjusts parameters of the scene reconstruction network according to a difference between the reconstructed image and the third image, to obtain a trained scene reconstruction network; the computer device performs, for each of the at least one key point, prediction based on the position information of the key point through the trained scene reconstruction network, to generate the photometric information of the key point; and the computer device determines the point cloud data of the first object based on the photometric information of the key point and the position information of the key point.

In an embodiment, the scene reconstruction network is configured to construct three-dimensional space, and the three-dimensional space is configured for reconstructing the first object and the real-world environment where the first object is located when the material images are captured.

In some embodiments, the scene reconstruction network is a Neural Radiance Fields (NeRF) network. In an embodiment, the generating a reconstructed image based on the third image and the camera parameters through a scene reconstruction network includes: The computer device determines a viewpoint position and a line-of-sight direction according to the camera parameters, the viewpoint position being configured for simulating, in three-dimensional space, a position in real space when the camera shoots the first object, and the line-of-sight direction being configured for simulating, in three-dimensional space, a light reflection direction of imaging the first object when the camera shoots the first object; and the computer device calculates an integral of photometric information of at least one point in the line-of-sight direction in three-dimensional space, to obtain a pixel value of a corresponding pixel point in the line-of-sight direction in the reconstructed image. When pixel values of corresponding pixels respectively in line-of-sight directions in the reconstructed image are determined, the reconstructed image can be obtained based on the pixel values of the pixels.

In an embodiment, the difference between the reconstructed image and the third image is calculated through Mean Squared Error. The computer device adjusts the network parameters of the scene reconstruction network by the gradient descent method.

In some embodiments, after the computer device performs key point identification on the material images, and generates point cloud data of the first object, the method further includes: The computer device performs plane fitting based on the point cloud data, to identify background points, the background points referring to plane key points unrelated to the first object in three-dimensional space; the computer device performs outlier identification based on the point cloud data, to determine at least one outlier point, the outlier point being a noise point caused by an environmental factor when the first object is shot; and the computer device deletes the background points and the outlier point from the point cloud data, to obtain processed point cloud data, the processed point cloud data being configured for performing three-dimensional reconstruction.

In an embodiment, the computer device fits and identifies a plane in the point cloud data based on the RANSAC algorithm. In this way, a planar structure, such as a ground or a wall, is removed from the point cloud data. In addition, some noise points or outlier points may exist in the point cloud data, and these points may be generated by factors such as a sensor error or reflection. To improve quality of the point cloud, these outlier points need to be identified and removed. Common methods include statistical outlier removal, a density-based method, and the like. Points in the point cloud data typically represent a plurality of different objects or scene structures. To separately process or model these structures, a point cloud needs to be segmented into a plurality of clusters or sets through Euclidean distance-based clustering.

In some embodiments, the computer device performs three-dimensional reconstruction based on the point cloud data, to determine a surface texture of the first object, including: performing Poisson reconstruction based on the point cloud data, to generate first texture information; and smoothing the first texture information to obtain second texture information, and simplifying the second texture information to obtain the surface texture of the first object.

In an embodiment, the computer device performs Poisson reconstruction based on the point cloud data, to generate first texture information, including: establishing an octree structure according to the position information of the key point, the octree structure including at least one leaf node having a same depth, and the leaf node including at least one key point located in the same three-dimensional space; and the computer device establishes an implicit function respectively corresponding to at least one leaf node, the implicit function being configured for calculating a normal vector of a key point included in the leaf node, and the normal vector of the key point being configured for representing an orientation of the key point on a local plane of a surface of the first object; solving parameters of the implicit function based on a finite element, to obtain a Poisson expression; determining an isosurface of the first object according to the Poisson expression, and triangulating the isosurface of the first object to generate the first texture information.

The following describes apparatus embodiments of the present disclosure, which can be configured for performing the method embodiments of the present disclosure. For details not disclosed in the apparatus embodiments of the present disclosure, refer to the method embodiments of the present disclosure.

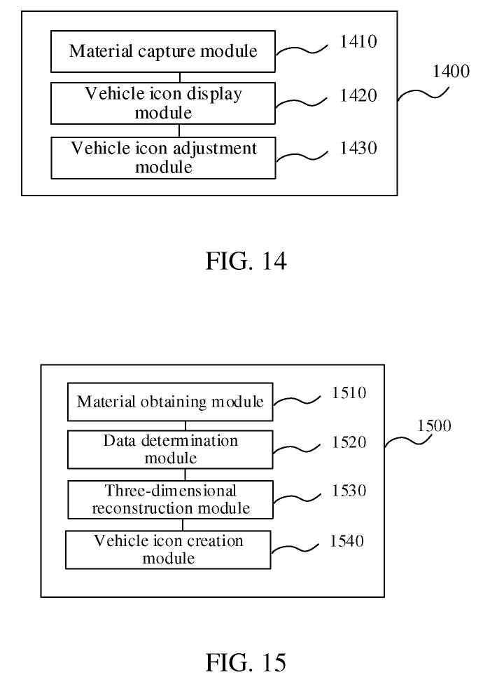

FIG. 14 is a block diagram of a three-dimensional navigation vehicle icon creation apparatus according to an exemplary embodiment of the present disclosure. An apparatus 1400 may include: a material capture module 1410, a vehicle icon display module 1420, and a vehicle icon adjustment module 1430.

The material capture module 1410 is configured to display material images of a first object on an image capture interface in response to an operation of capturing images, the material images including images obtained by shooting the first object from different shooting angles, and the first object being a three-dimensional physical object in a real-world environment.

The vehicle icon display module 1420 is configured to display a three-dimensional navigation vehicle icon of the first object, the three-dimensional navigation vehicle icon being obtained by performing three-dimensional reconstruction on the first object based on the material images.

The vehicle icon adjustment module 1430 is configured to display an adjusted three-dimensional navigation vehicle icon in response to an operation of adjusting a display style of the three-dimensional navigation vehicle icon, the adjusted three-dimensional navigation vehicle icon being displayed on a navigation interface.

In some embodiments, the display style includes an orientation of the three-dimensional navigation vehicle icon on the navigation interface; and the vehicle icon adjustment module 1430 is configured to rotate the orientation of the three-dimensional navigation vehicle icon in response to an operation of adjusting a posture of the three-dimensional navigation vehicle icon; and display the adjusted three-dimensional navigation vehicle icon in response to an operation of ending the adjustment of the posture of the three-dimensional navigation vehicle icon.

In some embodiments, the display style includes a surface texture of the three-dimensional navigation vehicle icon; and the vehicle icon adjustment module 1430 is configured to display at least one candidate surface texture, the candidate surface texture being generated based on an original surface texture of the three-dimensional navigation vehicle icon, and the original surface texture being configured for reflecting a surface material of the first object; display, in response to an operation of selecting a first surface texture from the at least one candidate surface texture, a three-dimensional navigation vehicle icon having the first surface texture as the adjusted three-dimensional navigation vehicle icon, the adjusted three-dimensional navigation vehicle icon being generated by performing texture mapping on point cloud data of the first object based on the first surface texture.

In some embodiments, the vehicle icon adjustment module 1430 is further configured to display a vehicle icon fusion interface, at least one decorative item being displayed on the vehicle icon fusion interface, and a three-dimensional model of the decorative item being preset; display a first decorative item at a first position in a surrounding box in response to an operation of selecting the first decorative item from the at least one decorative, the surrounding box being virtual three-dimensional space surrounding the three-dimensional navigation vehicle icon; and display a fused three-dimensional navigation vehicle icon in response to an operation of ending vehicle icon fusion, the fused three-dimensional navigation vehicle icon being obtained by fusing at least one three-dimensional model included in the surrounding box, and the fused three-dimensional navigation vehicle icon being displayed on the navigation interface.

In some embodiments, the apparatus 1400 further includes an image capture module, configured to display, on the image capture interface in response to an operation of triggering an image capture control, a field-of-view image of a process in which a camera captures the first object, the field-of-view image corresponding to the image; display first prompt information on a top layer of the field-of-view image, the first prompt information prompting a recommended movement trajectory for the camera to shoot the first object; and start to perform the operation of displaying the material images of the first object on the image capture interface in response to an operation of completing the capture of the material images.

In some embodiments, the apparatus 1400 further includes an information display module, configured to display second prompt information in response to an operation of performing three-dimensional reconstruction on the first object, the second prompt information prompting remaining creation duration of the three-dimensional navigation vehicle icon; and update the second prompt information at a first time interval if the remaining creation duration is greater than the first time interval, and display updated second prompt information until the creation of the three-dimensional navigation vehicle icon is completed.

In some embodiments, the information display module is further configured to display the second prompt information in response to that/when a data volume of the material images reaches an upper limit value and the operation of performing three-dimensional reconstruction on the first object is not received.

In some embodiments, the apparatus 1400 further includes an identifier determination module, configured to display identifier information of the three-dimensional navigation vehicle icon in response to an operation of setting the identifier information, the identifier information being configured for uniquely identifying the three-dimensional navigation vehicle icon; and start to perform the operation of displaying the three-dimensional navigation vehicle icon of the first object in response to that/when the identifier information of the three-dimensional navigation vehicle icon conforms to a naming rule and the material images conform to a content rule.

FIG. 15 is a block diagram of a three-dimensional navigation vehicle icon creation apparatus according to an exemplary embodiment of the present disclosure. An apparatus 1500 may include: a material obtaining module 1510, a data determination module 1520, a three-dimensional reconstruction module 1530, and a vehicle icon creation module 1540.

The material obtaining module 1510 is configured to obtain material images of a first object, the material images including images obtained by shooting the first object from different angles, and the first object being a three-dimensional physical object in a real-world environment.

The data determination module 1520 is configured to perform key point identification on the material images, to determine point cloud data of the first object, the point cloud data being configured for describing a position and a display style of the key point of the first object in the real-world environment.

The three-dimensional reconstruction module 1530 is configured to perform three-dimensional reconstruction based on the point cloud data, to determine an original surface texture of the first object, the original surface texture being configured for reflecting a surface material of the first object.

The vehicle icon creation module 1540 is configured to perform texture mapping on the point cloud data according to the surface texture of the first object, and create a three-dimensional navigation vehicle icon of the first object, the three-dimensional navigation vehicle icon being displayed on a navigation interface.

In some embodiments, the data determination module 1520 includes: a key point determination unit, configured to perform key point identification on a plurality of images in the material images, to separately determine key point information of each image, the key point information including a descriptor of the key point, and the descriptor being configured for representing a local structural feature of the key point in the image; a parameter determination unit, configured to determine camera parameters according to the key point information of the image, the camera parameters including an intrinsic camera parameter and an extrinsic camera parameter that are configured for capturing the material images; and a data determination unit, configured to determine the point cloud data of the first object according to the camera parameters.

In some embodiments, the key point determination unit is configured to perform, for each of the plurality of images, at least one blurring and downsampling on the image, to obtain a Gaussian image set, the Gaussian image set including a plurality of Gaussian image groups, and the Gaussian image group including Gaussian images with different blur degrees; separately perform, for each Gaussian image group, differential processing on every two adjacent Gaussian images in the Gaussian image group, to obtain a differential image group; determine at least one extremum point based on a pixel value change trend of a pixel in at least one differential image in the differential image group; and establish an extremum point change curve based on the at least one extremum point, determine at least one key point of the first object, and determine key point information of the image according to the at least one key point and the Gaussian image set.

In some embodiments, the parameter determination unit includes a key point contact subunit, configured to determine at least one key point chain according to key point information of the plurality of images, the key point chain being configured for representing changes of shooting positions of the plurality of images; a parameter estimation subunit, configured to perform parameter estimation according to the at least one key point chain, to determine initial parameters; and a parameter optimization subunit, configured to perform joint optimization on the at least one key point and the initial parameters, to obtain the camera parameters.

In some embodiments, the key point contact subunit is configured to perform, for each original image group in the material images, similarity matching on key point information of a first image and key point information of a second image in the original image group, to obtain at least one group of matching points, a difference between a shooting angle of the first image and a shooting angle of the second image being less than or equal to a first threshold; delete a noise point from the at least one group of matching points, to obtain at least one key point group; and perform similarity matching on key point groups of the material images, to determine the at least one key point chain, the key point groups of the material images including key point groups of the original image groups.

In some embodiments, the point cloud data includes position information of the key point and photometric information of the key point. The position information of the key point is determined according to the camera parameters and the material images, and the photometric information is configured for representing a display style of the key point. The data determination unit is configured to generate, for a third image in the material images, a reconstructed image based on the third image and the camera parameters through a scene reconstruction network; adjust parameters of the scene reconstruction network according to a difference between the reconstructed image and the third image, to obtain a trained scene reconstruction network; perform, for each of the at least one key point, prediction based on the position information of the key point through the trained scene reconstruction network, to generate the photometric information of the key point; and determine the point cloud data of the first object based on the photometric information of the key point and the position information of the key point.

In some embodiments, the apparatus 1500 further includes: a data optimization module, configured to perform plane fitting based on the point cloud data, to identify a background point, the background point being a plane key point that is unrelated to the first object in three-dimensional space; perform outlier identification based on the point cloud data, to determine at least one outlier point, the outlier point being a noise point caused by an environmental factor when the first object is shot; and delete the background point and the outlier point from the point cloud data, to obtain processed point cloud data, the processed point cloud data being configured for performing three-dimensional reconstruction.

When the apparatus provided in the foregoing embodiments implements functions of the apparatus, the division of the foregoing functional modules is merely an example for description. In the practical application, the foregoing functions may be assigned to and completed by different functional modules according to requirements, that is, an internal structure of a device is divided into different functional modules, to implement all or some of the functions described above. In addition, the apparatus provided in the foregoing embodiments and the method embodiments belong to the same conception. For a specific implementation process, refer to the method embodiments. Details are not described herein again. For beneficial effects of the apparatus provided in the foregoing embodiments, refer to the descriptions of the method embodiments. Details are not described herein again.

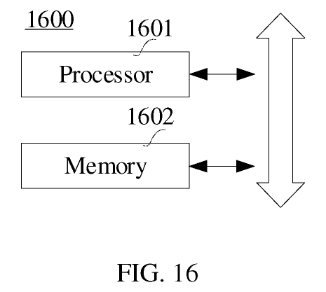

FIG. 16 is a structural block diagram of a computer device according to an exemplary embodiment of the present disclosure. A three-dimensional navigation vehicle icon creation device 1600 may be the computer device described above.

Generally, the computer device 1600 includes a processor 1601 and a memory 1602.

The processor 1601 may include one or more processing cores, for example, a 4-core processor or a 16-core processor. In some embodiments, the processor 1601 may further include an AI processor. The AI processor is configured to process computing operations related to machine learning.

The memory 1602 may include one or more computer-readable storage media. The computer-readable storage medium may be tangible and non-transitory. The memory 1602 may further include a high-speed random access memory, as well as a non-volatile memory, such as one or more disk storage devices and flash storage devices. In some embodiments, the non-transitory computer-readable storage medium in the memory 1602 has at least one computer program stored therein, and the at least one computer program is loaded and executed by the processor 1601 to implement the three-dimensional navigation vehicle icon creation method provided in the foregoing method embodiments.

An embodiment of the present disclosure further provides a computer-readable storage medium. The storage medium has a computer program therein stored therein, and the computer program is loaded and executed by a processor to implement the three-dimensional navigation vehicle icon method provided in the foregoing method embodiments.

The computer-readable medium may include a computer storage medium and a communication medium. The computer storage medium includes volatile and non-volatile media, and removable and non-removable media that are implemented by any method or technology for storing information such as computer-readable instructions, data structures, program modules, or other data.

An embodiment of the present disclosure further provides a computer program product. The computer program product includes a computer program, the computer program is stored in a computer-readable storage medium, and a processor reads the computer program from the computer-readable storage medium and executes the computer program to implement the three-dimensional navigation vehicle icon creation method provided in the foregoing method embodiments.

"A plurality of" mentioned herein means two or more. "And/or" describes an association relationship between associated objects and represents that three relationships may exist. For example, A and/or B may represent the following three cases: Only A exists, both A and B exist, and only B exists. The character "/" generally indicates an "or" relationship between the associated objects.

In the present disclosure, before related data of a user is collected and in a process of collecting the related data of the user, a prompt interface or a pop-up window may be displayed, or voice prompt information may be outputted. The prompt interface, the pop-up window, or the voice prompt information is configured for prompting the user that the related data of the user is being collected. Therefore, in the present disclosure, only after a confirmation operation performed by the user on the prompt interface or the pop-up window is obtained, a related operation of obtaining the related data of the user is performed, and otherwise (to be specific, when the confirmation operation performed by the user on the prompt interface or the pop-up window is not obtained), the related operation of obtaining the related data of the user ends, that is, the related data of the user is not obtained. In other words, in the present disclosure, the capture of the material images is conducted in compliance with relevant national laws and regulations. The informed consent or separate consent of personal information subjects is obtained only when users have agreed and provided authorization. Subsequent data usage and processing activities are carried out within the scope permitted by applicable laws, regulations, and the authorization granted by personal information subjects. Furthermore, the collection, use, and processing of relevant user data need to adhere to the applicable laws, regulations, and standards of the relevant countries and regions.

In various embodiments in the present disclosure, a module may refer to a software module, a hardware module, or a combination thereof. A software module may include a computer program or part of the computer program that has a predefined function and works together with other related parts to achieve a predefined goal, such as those functions described in this disclosure. A hardware module may be implemented using processing circuitry and/or memory configured to perform the functions described in this disclosure. Each module can be implemented using one or more processors (or processors and memory). Likewise, a processor (or processors and memory) can be used to implement one or more modules. Moreover, each module can be part of an overall module that includes the functionalities of the module. The description here also applies to the term module and other equivalent terms.

In some other embodiments, a computer-readable medium comprising instructions which, when executed by a computer, cause the computer to carry out a portion or all of the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software. In various embodiments in the present disclosure, the term “processor” may mean one processor that performs the defined functions, steps, or operations or a plurality of processors that collectively perform defined functions, steps, or operations, such that the execution of the individual defined functions may be divided amongst such plurality of processors.

The above are merely exemplary embodiments of the present disclosure, but are not intended to limit the present disclosure. Any modification, equivalent replacement, or improvement made within the spirit and principle of the present disclosure still falls within the scope of protection of the present disclosure.

What is claimed is:

1. A method for creating a three-dimensional navigation vehicle icon, executed by a computer device comprising a memory and a process in communication with the memory, the method comprising:
obtaining material images of a first object, the material images comprising images obtained by shooting the first object from different angles, and the first object being a three-dimensional physical object in a real-world environment;
performing key point identification on the material images, to generate point cloud data of the first object, the point cloud data being configured for describing a position and a display style of a key point of the first object in the real-world environment;
performing three-dimensional reconstruction based on the point cloud data, to determine an original surface texture of the first object, the original surface texture being configured for reflecting a surface material of the first object; and
performing texture mapping on the point cloud data according to the surface texture of the first object, and creating a three-dimensional navigation vehicle icon of the first object for being displayed on a navigation interface.

2. The method according to claim 1, wherein the performing key point identification on the material images, to generate the point cloud data of the first object comprises:
performing key point identification on a plurality of images in the material images, to separately determine key point information of each image, the key point information comprising a descriptor of the key point, and the descriptor being configured for representing a local structural feature of the key point in the image;
determining camera parameters according to the key point information of the image, the camera parameters comprising an intrinsic camera parameter and an extrinsic camera parameter that are configured for capturing the material images; and
generating the point cloud data of the first object according to the camera parameters.

3. The method according to claim 2, wherein the performing key point identification on the plurality of images in the material images, to separately determine the key point information of each image comprises:
performing, for each of the plurality of images, at least one blurring and downsampling on the image, to obtain a Gaussian image set, the Gaussian image set comprising a plurality of Gaussian image groups, and the Gaussian image group comprising Gaussian images with different blur degrees;
separately performing, for each of the Gaussian image groups, differential processing on every two adjacent Gaussian images in the Gaussian image group, to obtain a differential image group;
determining at least one extremum point based on a pixel value change trend of a pixel in at least one differential image in the differential image group;
establishing an extremum point change curve based on the at least one extremum point, and determining at least one key point of the first object; and
determining the key point information of the image according to the at least one key point and the Gaussian image set.

4. The method according to claim 2, wherein the determining the camera parameters according to the key point information of the image comprises:
determining at least one key point chain according to the key point information of the plurality of images, the key point chain being configured for representing changes of shooting positions of the plurality of images;
performing parameter estimation according to the at least one key point chain, to determine initial parameters; and
performing joint optimization on the at least one key point and the initial parameters, to obtain the camera parameters.

5. The method according to claim 4, wherein the determining the at least one key point chain according to the key point information of the plurality of images comprises:
performing, for each original image group in the material images, similarity matching on key point information of a first image and key point information of a second image in the original image group, to obtain at least one group of matching points, a difference between a shooting angle of the first image and a shooting angle of the second image being less than or equal to a first threshold;
deleting a noise point from the at least one group of matching points, to obtain at least one key point group; and
performing similarity matching on key point groups of the material images, to determine the at least one key point chain, the key point groups of the material images comprising key point groups of the original image groups.

6. The method according to claim 5, wherein:
the point cloud data comprises position information of the key point and photometric information of the key point, the position information of the key point is determined according to the camera parameters and the material images, and the photometric information is configured for representing a display style of the key point; and
the generating the point cloud data of the first object according to the camera parameters comprises:
generating, for a third image in the material images, a reconstructed image based on the third image and the camera parameters through a scene reconstruction network;
adjusting parameters of the scene reconstruction network according to a difference between the reconstructed image and the third image, to obtain a trained scene reconstruction network;
performing, for each of the at least one key point, prediction based on the position information of the key point through the trained scene reconstruction network, to generate the photometric information of the key point; and
generating the point cloud data of the first object based on the photometric information of the key point and the position information of the key point.

7. The method according to claim 1, wherein, after the performing key point identification on the material images, to generate point cloud data of the first object, the method further comprises:
performing plane fitting based on the point cloud data, to identify a background point, the background point being a plane key point unrelated to the first object in a three-dimensional space;
performing outlier identification based on the point cloud data, to determine at least one outlier point, the outlier point being a noise point caused by an environmental factor when the first object is shot; and
deleting the background point and the outlier point from the point cloud data, to obtain processed point cloud data for performing three-dimensional reconstruction.

8. An apparatus for creating a three-dimensional navigation vehicle icon, the apparatus comprising:
a memory storing instructions; and
a processor in communication with the memory, wherein, when the processor executes the instructions, the processor is configured to cause the apparatus to perform:
obtaining material images of a first object, the material images comprising images obtained by shooting the first object from different angles, and the first object being a three-dimensional physical object in a real-world environment;
performing key point identification on the material images, to generate point cloud data of the first object, the point cloud data being configured for describing a position and a display style of a key point of the first object in the real-world environment;
performing three-dimensional reconstruction based on the point cloud data, to determine an original surface texture of the first object, the original surface texture being configured for reflecting a surface material of the first object; and
performing texture mapping on the point cloud data according to the surface texture of the first object, and creating a three-dimensional navigation vehicle icon of the first object for being displayed on a navigation interface.

9. The apparatus according to claim 8, wherein, when the processor is configured to cause the apparatus to perform performing key point identification on the material images, to generate the point cloud data of the first object, the processor is configured to cause the apparatus to perform:
performing key point identification on a plurality of images in the material images, to separately determine key point information of each image, the key point information comprising a descriptor of the key point, and the descriptor being configured for representing a local structural feature of the key point in the image;
determining camera parameters according to the key point information of the image, the camera parameters comprising an intrinsic camera parameter and an extrinsic camera parameter that are configured for capturing the material images; and
generating the point cloud data of the first object according to the camera parameters.

10. The apparatus according to claim 9, wherein, when the processor is configured to cause the apparatus to perform performing key point identification on the plurality of images in the material images, to separately determine the key point information of each image, the processor is configured to cause the apparatus to perform:
performing, for each of the plurality of images, at least one blurring and downsampling on the image, to obtain a Gaussian image set, the Gaussian image set comprising a plurality of Gaussian image groups, and the Gaussian image group comprising Gaussian images with different blur degrees;
separately performing, for each of the Gaussian image groups, differential processing on every two adjacent Gaussian images in the Gaussian image group, to obtain a differential image group;
determining at least one extremum point based on a pixel value change trend of a pixel in at least one differential image in the differential image group;
establishing an extremum point change curve based on the at least one extremum point, and determining at least one key point of the first object; and
determining the key point information of the image according to the at least one key point and the Gaussian image set.

11. The apparatus according to claim 9, wherein, when the processor is configured to cause the apparatus to perform determining the camera parameters according to the key point information of the image, the processor is configured to cause the apparatus to perform:
determining at least one key point chain according to the key point information of the plurality of images, the key point chain being configured for representing changes of shooting positions of the plurality of images;
performing parameter estimation according to the at least one key point chain, to determine initial parameters; and
performing joint optimization on the at least one key point and the initial parameters, to obtain the camera parameters.

12. The apparatus according to claim 11, wherein, when the processor is configured to cause the apparatus to perform determining the at least one key point chain according to the key point information of the plurality of images, the processor is configured to cause the apparatus to perform:
performing, for each original image group in the material images, similarity matching on key point information of a first image and key point information of a second image in the original image group, to obtain at least one group of matching points, a difference between a shooting angle of the first image and a shooting angle of the second image being less than or equal to a first threshold;
deleting a noise point from the at least one group of matching points, to obtain at least one key point group; and
performing similarity matching on key point groups of the material images, to determine the at least one key point chain, the key point groups of the material images comprising key point groups of the original image groups.

13. The apparatus according to claim 12, wherein:
the point cloud data comprises position information of the key point and photometric information of the key point, the position information of the key point is determined according to the camera parameters and the material images, and the photometric information is configured for representing a display style of the key point; and
when the processor is configured to cause the apparatus to perform generating the point cloud data of the first object according to the camera parameters, the processor is configured to cause the apparatus to perform:
generating, for a third image in the material images, a reconstructed image based on the third image and the camera parameters through a scene reconstruction network;
adjusting parameters of the scene reconstruction network according to a difference between the reconstructed image and the third image, to obtain a trained scene reconstruction network;
performing, for each of the at least one key point, prediction based on the position information of the key point through the trained scene reconstruction network, to generate the photometric information of the key point; and
generating the point cloud data of the first object based on the photometric information of the key point and the position information of the key point.

14. The apparatus according to claim 8, wherein, after the processor is configured to cause the apparatus to perform performing key point identification on the material images, to generate point cloud data of the first object, the processor is configured to further cause the apparatus to perform:
performing plane fitting based on the point cloud data, to identify a background point, the background point being a plane key point unrelated to the first object in a three-dimensional space;
performing outlier identification based on the point cloud data, to determine at least one outlier point, the outlier point being a noise point caused by an environmental factor when the first object is shot; and
deleting the background point and the outlier point from the point cloud data, to obtain processed point cloud data for performing three-dimensional reconstruction.

15. A non-transitory computer-readable storage medium, storing computer-readable instructions, wherein, the computer-readable instructions, when executed by a processor, are configured to cause the processor to perform:
obtaining material images of a first object, the material images comprising images obtained by shooting the first object from different angles, and the first object being a three-dimensional physical object in a real-world environment;
performing key point identification on the material images, to generate point cloud data of the first object, the point cloud data being configured for describing a position and a display style of a key point of the first object in the real-world environment;
performing three-dimensional reconstruction based on the point cloud data, to determine an original surface texture of the first object, the original surface texture being configured for reflecting a surface material of the first object; and
performing texture mapping on the point cloud data according to the surface texture of the first object, and creating a three-dimensional navigation vehicle icon of the first object for being displayed on a navigation interface.

16. The non-transitory computer-readable storage medium according to claim 15, wherein, when the computer-readable instructions are configured to cause the processor to perform performing key point identification on the material images, to generate the point cloud data of the first object, the computer-readable instructions are configured to cause the processor to perform:
performing key point identification on a plurality of images in the material images, to separately determine key point information of each image, the key point information comprising a descriptor of the key point, and the descriptor being configured for representing a local structural feature of the key point in the image;
determining camera parameters according to the key point information of the image, the camera parameters comprising an intrinsic camera parameter and an extrinsic camera parameter that are configured for capturing the material images; and
generating the point cloud data of the first object according to the camera parameters.

17. The non-transitory computer-readable storage medium according to claim 16, wherein, when the computer-readable instructions are configured to cause the processor to perform performing key point identification on the plurality of images in the material images, to separately determine the key point information of each image, the computer-readable instructions are configured to cause the processor to perform:
performing, for each of the plurality of images, at least one blurring and downsampling on the image, to obtain a Gaussian image set, the Gaussian image set comprising a plurality of Gaussian image groups, and the Gaussian image group comprising Gaussian images with different blur degrees;
separately performing, for each of the Gaussian image groups, differential processing on every two adjacent Gaussian images in the Gaussian image group, to obtain a differential image group;
determining at least one extremum point based on a pixel value change trend of a pixel in at least one differential image in the differential image group;
establishing an extremum point change curve based on the at least one extremum point, and determining at least one key point of the first object; and
determining the key point information of the image according to the at least one key point and the Gaussian image set.

18. The non-transitory computer-readable storage medium according to claim 16, wherein, when the computer-readable instructions are configured to cause the processor to perform determining the camera parameters according to the key point information of the image, the computer-readable instructions are configured to cause the processor to perform:
determining at least one key point chain according to the key point information of the plurality of images, the key point chain being configured for representing changes of shooting positions of the plurality of images;
performing parameter estimation according to the at least one key point chain, to determine initial parameters; and
performing joint optimization on the at least one key point and the initial parameters, to obtain the camera parameters.

19. The non-transitory computer-readable storage medium according to claim 18, wherein, when the computer-readable instructions are configured to cause the processor to perform determining the at least one key point chain according to the key point information of the plurality of images, the computer-readable instructions are configured to cause the processor to perform:
performing, for each original image group in the material images, similarity matching on key point information of a first image and key point information of a second image in the original image group, to obtain at least one group of matching points, a difference between a shooting angle of the first image and a shooting angle of the second image being less than or equal to a first threshold;
deleting a noise point from the at least one group of matching points, to obtain at least one key point group; and
performing similarity matching on key point groups of the material images, to determine the at least one key point chain, the key point groups of the material images comprising key point groups of the original image groups.

20. The non-transitory computer-readable storage medium according to claim 15, wherein, after the computer-readable instructions are configured to cause the processor to perform performing key point identification on the material images, to generate point cloud data of the first object, the computer-readable instructions are configured to further cause the processor to perform:
performing plane fitting based on the point cloud data, to identify a background point, the background point being a plane key point unrelated to the first object in a three-dimensional space;
performing outlier identification based on the point cloud data, to determine at least one outlier point, the outlier point being a noise point caused by an environmental factor when the first object is shot; and
deleting the background point and the outlier point from the point cloud data, to obtain processed point cloud data for performing three-dimensional reconstruction.
